(19) United States
(12) Patent Application Publication
(10) Pub. No.: US 2016/0071058 A1
(43) Pub. Date: Mar. 10, 2016

(54) SYSTEM AND METHODS FOR CREATING, MODIFYING AND DISTRIBUTING VIDEO CONTENT USING CROWD SOURCING AND CROWD CURATION

(71) Applicants: Sony Corporation, Tokyo (JP); Sony Network Entertainment International, Inc., Los Angeles, CA (US)

(72) Inventor: Albhy Galuten, Santa Monica, CA (US)

(21) Appl. No.: 14/846,624

(22) Filed: Sep. 4, 2015

Related U.S. Application Data
(60) Provisional application No. 62/046,501, filed on Sep. 5, 2014.

(51) Int. Cl. G06Q 10/10; G06Q 50/18; G06F 17/30; G06Q 50/00; G06Q 10/06

(52) U.S. Cl. CPC G06Q 10/101; G06Q 50/01; G06Q 10/0637; G06F 17/3082; G06F 17/30353; G06Q 50/188; G06Q 50/184

(57) ABSTRACT

A method and system for authoring, writing, filming, editing and the addition of special effects using social networks and cloud-computing and the curation, marketing and distribution of videos using the collective intelligence of large numbers of participants is described herein. Using either a public network of anonymous or semi-anonymous users or a private network of registered participants, multiple people can work on and/or curate scripts, shoot video, edit video, apply special effects or devise marketing or distribution plans. The people who work together in the creative process can be selected using historical performance data and reputation indices and may be selected from a pool of millions of potential contributors. Legal structures can be changed to automate ownership and credits. The filming, special effects and editing can all be done in the cloud by people dynamically chosen, and decisions regarding creative and technical choices can be optimized using crowd wisdom techniques.

### CROSS-REFERENCE TO RELATED APPLICATION(S)

This application claims priority under 35 U.S.C. §119(e) of the U.S. Provisional Patent Application Ser. No. 62/046,501, filed Sep. 5, 2014 and titled, “SYSTEM AND METHODS FOR CREATING, MODIFYING AND DISTRIBUTING VIDEO CONTENT USING CROWD SOURCING AND CROWD CURATION,” which is hereby incorporated by reference in its entirety for all purposes.

### FIELD OF THE INVENTION

The system and methods pertain generally to video authoring, writing, filming, editing and the addition of special effects using social networks and cloud-computing and the curation, marketing and distribution of videos using the collective intelligence of large numbers of participants.

### BACKGROUND OF THE INVENTION

Today, there is a gulf in capabilities between professionally created videos like NetworkTV shows and theatrical movies and video content created by lay persons. Most “commercial quality” video is created using professional tools and equipment while “home videos” are created using consumer tools. The quality of consumer tools is continually increasing. Another factor in today's video creation space is the location of those tools and the processing power needed to effectuate complex editing and special effects. Today, these tools are mostly local, that is on a computer or local area network with proximity to and under the control of those who are using them. At the same time, the “cloud” is providing available processing and storage that will eventually dwarf the capabilities of local processing and storage. A third factor in today's commercial video creation is the process for finding and approving professional quality content beginning as early as the initial writing. This is currently done, for the most part, using personal relationships among a limited number of professional agents and studio executives. The execution of that idea all the way through creation of the final content and the approval processes associated with that creative work is generally managed by a limited number of studio employees and outside workers (e.g., Directors, Actors, Show Runners, Directors of Photography, Editors, and others). The fourth factor has to do with the selection of independently made titles for distribution based on the data associated with early consumption habits and using the habits of classes of individuals to determine if and when titles should be licensed for wider distribution. Early consumer behavior is able to be used to predict the likelihood of success of various media properties and various contributors to more properly inform content acquisition and distribution strategies The fifth factor is with regard to marketing and distribution. Marketing and distribution of commercial content today is mostly to anonymous consumers. There have been numerous attempts to know more about the individual consumer and to recommend things that might be appropriate. In the future, with big data in the cloud, there will be access to very granular information about individual consumers including everything from their previous video likes to their consumption habits of other products to their association with other consumers based on those habits.

U.S. Patent Application Publication No. 2002/0123956, titled, “Method and system for creating and verifying derivative contract terms using party relationships,” discusses ways of determining and verifying derivative contract terms using party relationships.

### BRIEF SUMMARY OF THE INVENTION

The summary herein includes exemplary embodiments and is not meant to be limiting in any way.

The system and methods reflect a complete change in the way video is created and curated and also a change in the way it is distributed. Beginning with an idea, multiple people who may not typically know each other at all will be able to work on and curate scripts. The people who work together in the creative process is able to be selected using historical performance data and reputation indices and may be selected from a pool of thousands or millions of potential contributors. Legal structures are able to be changed to automate ownership and credits and to limit liability and potential litigation. Not only is the ideal creation able to be developed using the wisdom of the crowds, but the actual production is able to be managed using persons found by similar mechanisms (reputation, experience, others). The filming, special effects and editing are all able to be done in the cloud by people dynamically chosen (and paid and credited) and decisions regarding creative and technical choices are able to be optimized using crowd wisdom techniques. Additionally, the system and methods speak to a new way to optimize distribution based on information about individual consumers, groups of consumers and relationships among consumers. Content is able to not only be targeted at individual consumers, but the creative process is able to be influenced by the choices those consumers make creating a dynamic feedback loop that changes content based on consumer behavior and expectations around that behavior.

In one aspect, a method programmed in a non-transitory memory of a device comprises digitally registering an original script, defining and instantiating parameters of ownership and control related to the original script in an electronic contract, reviewing the original script among participants who are covered by the electronic contract, selecting and binding, by electronic contract, the participants who are to work on the original script, capturing a video or audio based on the original script using the participants, implementing digital effects on the video or audio using the participants, editing the video or audio using the participants and selecting a marketing plan using the participants. The original script includes a standard script, a reality show idea or a documentary idea. The method further comprises generating the original script including: binding of the original script to a creator using digital credentials, generating the electronic contract representing terms of the binding and registration of the original script with an electronic repository comprising the original script, certification of ownership of the original script and the binding to the electronic contract which governs control of the original script. The electronic contract comprises: a data structure configured for containing rules of governance, control and ownership, a binding electronic signature associated with each real person or legal entity guaranteeing their acceptance of the terms of the contract and agreeing to be bound by the contract, an association of the electronic signature to an electronic signature authority which attests to the validity of the electronic signatures and governance rules and policies which determine policies for voting, policies for change of control, policies for change of ownership and venue of governing law. The method further comprises generating and updating the electronic contract comprising: utilizing an electronic contract stub into which all entities, control, ownership and governance policies are placed, associating the electronic contract with a parent entity that is uniquely identified, associating the electronic contract with a first attested entity, selection of parameters of governance, associating control and ownership parameters, associating and binding of additional entities including levels of ownership and control of any payment, electronic voting on the additional entities by existing entities and notifying the additional entities. The method further comprises registering the original script comprising: registering the original script with an electronic storage repository which guarantees that no modifications have been made or are able to be made, date and time stamping the original script so that the time of registrations is able to be determined and recording a digital signature of a registering entity and an attestation that the registering entity is the controlling entity for the original script. Binding the participants includes: the electronic contract which is associated with registration at the time of the registration so all parameters of ownership and control of the original script at the time are able to be determined, identification and location of the electronic contract and identification of all controlling entities as represented by the electronic contract. The method further comprises determining a reputation of each of the participants, including: storing the reputation in one or more reputation information databases, collating reputations before being placed in the one or more reputation information databases, collecting data from multiple sources to determine the reputation, the multiple sources including: anonymous contributions found on web logs or web sites and viability of the web logs and web sites and the individual contributions is weighted based on popularity and historical data, box office grosses and box office location and size, television rating services, awards and reviews or identified persons or entities with a system or another peered system, wherein the weighting of the value of the recommendations of the identified persons or entities is increased or decreased based on relevancy parameters and on veracity parameters, wherein further weighting of the recommendations of the identified persons or entities is increased or decreased based on their association with other identified persons or entities who are more or less highly rated. Generating the original script includes using a number of persons or entities, wherein: an initial writer is associated by the electronic contract to the entity which controls the original script, additional writers are added as controlled by the electronic contract and as selected from a collection of registered writers, wherein such selection is informed by use of a reputation engine, wherein changes of control or ownership are proposed and voted upon using electronic contract governance. The original script is related to a documentary, wherein generating the documentary includes: using a number of persons or entities in generating the documentary, wherein a documentary producer is associated with a production entity, a director of photography is associated with that production entity, one or more editors may be associated with that production entity, individual camera operators agree to submit footage based on a form of agreed electronic contract, the footage is stored or referenced in a footage repository, the footage is rated based on opinions of the participants who have access to the footage referenced in the repository, opinions of the participants are weighted based on the reputations associated with the participants, and payments and credits are given to the camera operators as prescribed in the electronic contract. The method further comprises generating and using the footage repository includes: associating footage with the camera operators using digital identifiers, associating metadata with the footage based on a reputation information database, wherein the reputation information database is informed by the data of registered reviewers, wherein the reputation information database is informed by a reputation engine, wherein the reputation engine is informed by data from anonymous reviewers, wherein the reputation engine informs a clip metadata parser, wherein the clips informed are stack-ranked for applicability, and wherein the director of photography, the editor, the producer and the director use the clips and the associated metadata and ranking data for generating the original script. The original script is related to reality programming, including: registering a reality programming idea by a reality producer, sending out a call for actors, receiving signatures of electronic contracts and footage, receiving votes by registered and non-registered users for actors, weighting the votes, putting scenes together by an editor, receiving votes by the registered and the non-registered users for the scenes, weighting the votes, compiling additional scenes and votes and releasing a finished product. The method further comprises searching for and adding talent, including: using a reputation engine to review a pool of professional talent, using a different reputation engine to review a pool of amateur talent, after potential talent is ranked from most viable to least viable, contacting the talent, offering an electronic contracts to selected talent and digitally signing electronic contracts, after negotiation. The method further comprises connecting legal resources with entities or persons including: searching a pool of registered lawyers, filtering the pool of lawyers based on reputation, pricing and applicability to the required work and negotiate electronic contracts which are signed by various entities using the lawyers representing the entities in the negotiation. The method further comprises collecting data from amateurs including: aggregating links to footage from unregistered users along with other metadata associated with the footage, aggregating and associating viewers associated with the footage, aggregating and associating comments associated with the footage, transforming the associated comments into performance quality metadata, factoring quality and reputation indices and collating the data in preparation for ranking and ranking videos against desired goals of the footage. The method further comprises finding talent from among a large mass of public videos including: populating a metadata repository with persons from fields of a filming process endeavor, optimizing groups of fields of endeavor to separate each individual into the field or fields of endeavor most appropriate, based on a plurality of axes, the persons are additionally ranked based on recommendations associated with their capabilities, based on the data and rankings, making electronic offers and memorializing accepted offers in electronic contracts. The method further comprises finding a video with commercial potential from a mass of public videos including: generating a database of titles, creators and owners, merging a title, creator and owner database with viewer usage metadata, filtering and optimizing the metadata by following bell weather users, popularity optimization, time, place and viewing behavior optimization and other filters and optimizations, feeding a popularity trajectory predictor the optimizers and filters, matching popularity trajectory against market analysis and feeding results from the above steps into a distribution entity which determines distribution opportunities based on rankings and target audiences discovered.

In another aspect a system comprises a registration module configured for digitally registering an original script, a parameter module configured for defining and instantiating parameters of ownership and control related to the original script in an electronic contract, a review module configured for reviewing the original script among participants who are covered by the electronic contract, a selection module configured for selecting and binding, by electronic contract, the participants who are to work on the original script, a capture module configured for capturing a video or audio based on the original script using the participants, an effects module configured for implementing digital effects on the video or audio using the participants, an editing module configured for editing the video or audio using the participants and a plan module configured for selecting a marketing plan using the participants. The original script includes a standard script, a reality show idea or a documentary idea. The system further comprises a generation module configured for generating the original script including: binding of the original script to a creator using digital credentials, generating the electronic contract representing terms of the binding and registration of the original script with an electronic repository comprising the original script, certification of ownership of the original script and the binding to the electronic contract which governs control of the original script. The electronic contract comprises: a data structure configured for containing rules of governance, control and ownership, a binding electronic signature associated with each real person or legal entity guaranteeing their acceptance of the terms of the contract and agreeing to be bound by the contract, an association of the electronic signature to an electronic signature authority which attests to the validity of the electronic signatures and governance rules and policies which determine policies for voting, policies for change of control, policies for change of ownership and venue of governing law. The system further comprises an update module configured for generating and updating the electronic contract comprising: utilizing an electronic contract stub into which all entities, control, ownership and governance policies are placed, associating the electronic contract with a parent entity that is uniquely identified, associating the electronic contract with a first attested entity, selection of parameters of governance, associating control and ownership parameters, associating and binding of additional entities including levels of ownership and control of any payment, electronic voting on the additional entities by existing entities and notifying the additional entities. The system further comprises a script module configured for registering the original script comprising: registering the original script with an electronic storage repository which guarantees that no modifications have been made or are able to be made, date and time stamping the original script so that the time of registrations is able to be determined and recording a digital signature of a registering entity and an attestation that the registering entity is the controlling entity for the original script. Binding the participants includes: the electronic contract which is associated with registration at the time of the registration so all parameters of ownership and control of the original script at the time are able to be determined, identification and location of the electronic contract and identification of all controlling entities as represented by the electronic contract. The system further comprises a reputation module configured for determining a reputation of each of the participants, including: storing the reputation in one or more reputation information databases, collating reputations before being placed in the one or more reputation information databases, collecting data from multiple sources to determine the reputation, the multiple sources including: anonymous contributions found on web logs or web sites and viability of the web logs and web sites and the individual contributions is weighted based on popularity and historical data, box office grosses and box office location and size, television rating services, awards and reviews or identified persons or entities with a system or another peered system, wherein the weighting of the value of the recommendations of the identified persons or entities is increased or decreased based on relevancy parameters and on veracity parameters, wherein further weighting of the recommendations of the identified persons or entities is increased or decreased based on their association with other identified persons or entities who are more or less highly rated. Generating the original script includes using a number of persons or entities, wherein: an initial writer is associated by the electronic contract to the entity which controls the original script, additional writers are added as controlled by the electronic contract and as selected from a collection of registered writers, wherein such selection is informed by use of a reputation engine, wherein changes of control or ownership are proposed and voted upon using electronic contract governance. The original script is related to a documentary, wherein generating the documentary includes: using a number of persons or entities in generating the documentary, wherein a documentary producer is associated with a production entity, a director of photography is associated with that production entity, one or more editors may be associated with that production entity, individual camera operators agree to submit footage based on a form of agreed electronic contract, the footage is stored or referenced in a footage repository, the footage is rated based on opinions of the participants who have access to the footage referenced in the repository, opinions of the participants are weighted based on the reputations associated with the participants, and payments and credits are given to the camera operators as prescribed in the electronic contract. The system further comprises a repository module configured for generating and using the footage repository includes: associating footage with the camera operators using digital identifiers, associating metadata with the footage based on a reputation information database, wherein the reputation information database is informed by the data of registered reviewers, wherein the reputation information database is informed by a reputation engine, wherein the reputation engine is informed by data from anonymous reviewers, wherein the reputation engine informs a clip metadata parser, wherein the clips informed are stack-ranked for applicability, and wherein the director of photography, the editor, the producer and the director use the clips and the associated metadata and ranking data for generating the original script. The original script is related to reality programming, including: registering a reality programming idea by a reality producer, sending out a call for actors, receiving signatures of electronic contracts and footage, receiving votes by registered and non-registered users for actors, weighting the votes, putting scenes together by an editor, receiving votes by the registered and the non-registered users for the scenes, weighting the votes, compiling additional scenes and votes and releasing a finished product. The system further comprises a talent module configured for searching for and adding talent, including: using a reputation engine to review a pool of professional talent, using a different reputation engine to review a pool of amateur talent, after potential talent is ranked from most viable to least viable, contacting the talent, offering an electronic contracts to selected talent and digitally signing electronic contracts, after negotiation. The system further comprises a legal module configured for connecting legal resources with entities or persons including: searching a pool of registered lawyers, filtering the pool of lawyers based on reputation, pricing and applicability to the required work and negotiate electronic contracts which are signed by various entities using the lawyers representing the entities in the negotiation. The system further comprises an amateur module configured for collecting data from amateurs including: aggregating links to footage from unregistered users along with other metadata associated with the footage, aggregating and associating viewers associated with the footage, aggregating and associating comments associated with the footage, transforming the associated comments into performance quality metadata, factoring quality and reputation indices and collating the data in preparation for ranking and ranking videos against desired goals of the footage. The system further comprises a mass module configured for finding talent from among a large mass of public videos including: populating a metadata repository with persons from fields of a filming process endeavor, optimizing groups of fields of endeavor to separate each individual into the field or fields of endeavor most appropriate, based on a plurality of axes, the persons are additionally ranked based on recommendations associated with their capabilities, based on the data and rankings, making electronic offers and memorializing accepted offers in electronic contracts. The system further comprises a commercial module configured for finding a video with commercial potential from a mass of public videos including: generating a database of titles, creators and owners, merging a title, creator and owner database with viewer usage metadata, filtering and optimizing the metadata by following bell weather users, popularity optimization, time, place and viewing behavior optimization and other filters and optimizations, feeding a popularity trajectory predictor the optimizers and filters, matching popularity trajectory against market analysis and feeding results from the above steps into a distribution entity which determines distribution opportunities based on rankings and target audiences discovered.

In another aspect, an apparatus comprises a non-transitory memory for storing an application, the application for: digitally registering an original script, defining and instantiating parameters of ownership and control related to the original script in an electronic contract, reviewing the original script among participants who are covered by the electronic contract, selecting and binding, by electronic contract, the participants who are to work on the original script, capturing a video or audio based on the original script using the participants, implementing digital effects on the video or audio using the participants, editing the video or audio using the participants and selecting a marketing plan using the participants and a processing component coupled to the memory, the processing component configured for processing the application. The original script includes a standard script, a reality show idea or a documentary idea. The application is further for generating the original script including: binding of the original script to a creator using digital credentials, generating the electronic contract representing terms of the binding and registration of the original script with an electronic repository comprising the original script, certification of ownership of the original script and the binding to the electronic contract which governs control of the original script. The electronic contract comprises: a data structure configured for containing rules of governance, control and ownership, a binding electronic signature associated with each real person or legal entity guaranteeing their acceptance of the terms of the contract and agreeing to be bound by the contract, an association of the electronic signature to an electronic signature authority which attests to the validity of the electronic signatures and governance rules and policies which determine policies for voting, policies for change of control, policies for change of ownership and venue of governing law. The application is further for generating and updating the electronic contract comprising: utilizing an electronic contract stub into which all entities, control, ownership and governance policies are placed, associating the electronic contract with a parent entity that is uniquely identified, associating the electronic contract with a first attested entity, selection of parameters of governance, associating control and ownership parameters, associating and binding of additional entities including levels of ownership and control of any payment, electronic voting on the additional entities by existing entities and notifying the additional entities. The application is further for registering the original script comprising: registering the original script with an electronic storage repository which guarantees that no modifications have been made or are able to be made, date and time stamping the original script so that the time of registrations is able to be determined and recording a digital signature of a registering entity and an attestation that the registering entity is the controlling entity for the original script. Binding the participants includes: the electronic contract which is associated with registration at the time of the registration so all parameters of ownership and control of the original script at the time are able to be determined, identification and location of the electronic contract and identification of all controlling entities as represented by the electronic contract. The application is further for comprises determining a reputation of each of the participants, including: storing the reputation in one or more reputation information databases, collating reputations before being placed in the one or more reputation information databases, collecting data from multiple sources to determine the reputation, the multiple sources including: anonymous contributions found on web logs or web sites and viability of the web logs and web sites and the individual contributions is weighted based on popularity and historical data, box office grosses and box office location and size, television rating services, awards and reviews or identified persons or entities with a system or another peered system, wherein the weighting of the value of the recommendations of the identified persons or entities is increased or decreased based on relevancy parameters and on veracity parameters, wherein further weighting of the recommendations of the identified persons or entities is increased or decreased based on their association with other identified persons or entities who are more or less highly rated. Generating the original script includes using a number of persons or entities, wherein: an initial writer is associated by the electronic contract to the entity which controls the original script, additional writers are added as controlled by the electronic contract and as selected from a collection of registered writers, wherein such selection is informed by use of a reputation engine, wherein changes of control or ownership are proposed and voted upon using electronic contract governance. The original script is related to a documentary, wherein generating the documentary includes: using a number of persons or entities in generating the documentary, wherein a documentary producer is associated with a production entity, a director of photography is associated with that production entity, one or more editors may be associated with that production entity, individual camera operators agree to submit footage based on a form of agreed electronic contract, the footage is stored or referenced in a footage repository, the footage is rated based on opinions of the participants who have access to the footage referenced in the repository, opinions of the participants are weighted based on the reputations associated with the participants, and payments and credits are given to the camera operators as prescribed in the electronic contract. The application is further for generating and using the footage repository includes: associating footage with the camera operators using digital identifiers, associating metadata with the footage based on a reputation information database, wherein the reputation information database is informed by the data of registered reviewers, wherein the reputation information database is informed by a reputation engine, wherein the reputation engine is informed by data from anonymous reviewers, wherein the reputation engine informs a clip metadata parser, wherein the clips informed are stack-ranked for applicability, and wherein the director of photography, the editor, the producer and the director use the clips and the associated metadata and ranking data for generating the original script. The original script is related to reality programming, including: registering a reality programming idea by a reality producer, sending out a call for actors, receiving signatures of electronic contracts and footage, receiving votes by registered and non-registered users for actors, weighting the votes, putting scenes together by an editor, receiving votes by the registered and the non-registered users for the scenes, weighting the votes, compiling additional scenes and votes and releasing a finished product. The application is further for searching for and adding talent, including: using a reputation engine to review a pool of professional talent, using a different reputation engine to review a pool of amateur talent, after potential talent is ranked from most viable to least viable, contacting the talent, offering an electronic contracts to selected talent and digitally signing electronic contracts, after negotiation. The application is further for connecting legal resources with entities or persons including: searching a pool of registered lawyers, filtering the pool of lawyers based on reputation, pricing and applicability to the required work and negotiate electronic contracts which are signed by various entities using the lawyers representing the entities in the negotiation. The application is further for collecting data from amateurs including: aggregating links to footage from unregistered users along with other metadata associated with the footage, aggregating and associating viewers associated with the footage, aggregating and associating comments associated with the footage, transforming the associated comments into performance quality metadata, factoring quality and reputation indices and collating the data in preparation for ranking and ranking videos against desired goals of the footage. The application is further for finding talent from among a large mass of public videos including: populating a metadata repository with persons from fields of a filming process endeavor, optimizing groups of fields of endeavor to separate each individual into the field or fields of endeavor most appropriate, based on a plurality of axes, the persons are additionally ranked based on recommendations associated with their capabilities, based on the data and rankings, making electronic offers and memorializing accepted offers in electronic contracts. The application is further for finding a video with commercial potential from a mass of public videos including: generating a database of titles, creators and owners, merging a title, creator and owner database with viewer usage metadata, filtering and optimizing the metadata by following bell weather users, popularity optimization, time, place and viewing behavior optimization and other filters and optimizations, feeding a popularity trajectory predictor the optimizers and filters, matching popularity trajectory against market analysis and feeding results from the above steps into a distribution entity which determines distribution opportunities based on rankings and target audiences discovered.

### BRIEF DESCRIPTION OF THE DRAWINGS

The invention will be more fully understood by reference to the following drawings which are for illustrative purposes only:

FIG. 1 is a high level overview of the steps in the creative process up to the distribution of the filmed/video asset.

FIG. 2 is a view of the script registration flow.

FIG. 3 is a view of the contractual parameters of script ownership and control.

FIG. 4 is a view of the parsing flows for e-contracts.

FIG. 5 is a view of the process for registering ideas and scripts.

FIG. 6 is a view that shows the linking of the content registry and the e-contracts.

FIG. 7 is a view that shows the participant selection flow.

FIG. 8 is a view that shows the functioning of granular reputation engine.

FIG. 9 is a view of the Scripted Agora.

FIG. 10 is a view of the Documentary Agora.

FIG. 11 is a view of the Footage Repository.

FIG. 12 is a view of the Reality Agora.

FIG. 13 is a view of the Agency Agora.

FIG. 14 is a view of the Legal Agora.

FIG. 15 is a view of the Filming Agora.

FIG. 16 is a view of the Special Effects process.

FIG. 17 is a view of the Amateur Agora, Collecting Data.

FIG. 18 is a view of the Amateur Agora, Finding Talent.

FIG. 19 is a view of the Distributed Video Agora, Finding Commercial Videos.

FIG. 20 illustrates a block diagram of an exemplary computing device configured to implement the video development method according to some embodiments.

### DETAILED DESCRIPTION OF THE PREFERRED EMBODIMENT

The video development method is broken into a number of serial and parallel processes. The Idea:

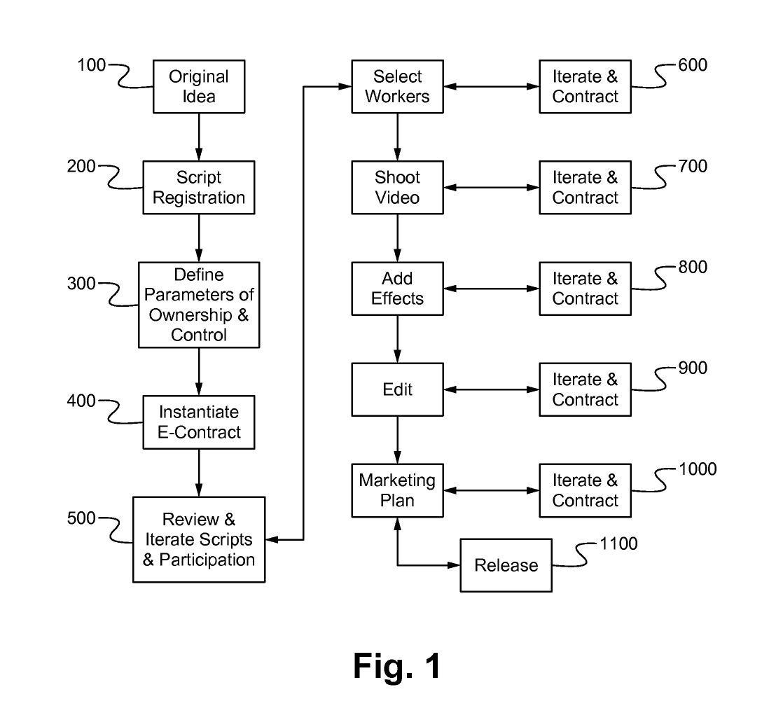

Video content begins with an idea. This could be an idea for a scripted TV show or series or a theatrical movie. It could also be an idea for a framework for a reality TV show or a documentary. The idea needs to be instantiated and protected and the legal arrangement among the creators needs to be codified and registered. Current copyright registration is not granular enough to sufficiently protect the contributions of multiple parties who do not have a pre-defined working relationship. The video development method defines a chain of participation that is both granular and accountable. An overview of the complete process is able to be seen in FIG. 1 (Lifecycle Overview).

A Project or Original Idea (100) is started by one or more “originators.” These originators register their first script or their outline for a reality show or a documentary (200). All participants registering their participation (either initially or later) must have credentials that are able to be associated with their real person or entity. Each entity (a corporation or partnership could be a participant) must have a digital signature which is binding in a court of law and a mechanism for assuring the robustness of that signature as outlined in, for example the United Nations Convention on the Use of Electronic Communications in International Contracts or as provided by mechanisms like DocuSign or EchoSign.

The registration defines both the percentage of ownership and the percentage of control (300) and is stored in detail in an Electronic or E-Contract. All decisions made after this are subject to a secure vote of the participants based on their percentage of control. Revenues that accrue are based on the percentage of ownership. Some decisions may be designated as “super-majority” decisions. Super majority decisions are able to be defined as a percentage of participants from anywhere greater than 50% to 100%. So, for example, if there are 5 people who equally share control (20% each), and they select a super-majority of 80%, and they determine, for example, that in order to sell all of the rights, there must be a super-majority, then four people would need to agree in order to sell the property. There are able to be multiple levels of super-majority, (e.g. super-majority1, super-majority2, super-majority3, and so on), and these are able to be associated with percentages. Typically, one level might be set at 100% (unanimity) for the most important decisions. Having multiple levels of super-majority might be most relevant when there are a large number of participants (there could be hundreds).

As is described herein, people other than creators are able to be involved in either the ownership or the control. For example an actor or a director might have a percentage of either or both. Again, by way of example, suppose a writer has created a script and wants to bring on a Producer and a Director. That writer might give the Director and Producer certain levels of control based on their bi-lateral negotiation—e.g., 25% for the Producer and 35% for the Director, leaving 40% for the original creator. The three parties might then agree to be bound by three different super-majorities: 60% (or super-majority1) for decisions that are able to be made by any two of the three participants, 65% (or super-majority2) for decisions that are able to be made by the Creator in agreement with either the Producer or the Director and 100% (or supermajority 3) for those decision that require unanimous agreement. At some point, they convince a distributor to get involved. They might agree to give that distributor 75% ownership until costs are recouped and 50% ownership after that in exchange for an agreed amount of money they will commit to fund and market the production and distribute the title. However, they might cede only 49% of the control so that if the three original principles make a decision, the distributor cannot unilaterally veto it. Also, non-votes or abstentions are able to be counted as either no votes or as not part of the percentage (as is common in different kinds of governing structures).

Continuing with FIG. 1 (Lifecycle Overview), next the content is iterated and reviewed (500). During this process other workers are found and their degree of control or participation or other form of remuneration is negotiated and securely and robustly codified in continuing E-Contracts or extensions of existing E-Contracts. As various workers are found (writers, actors, others), they are reviewed and contracts are negotiated and signed (600). This process is repeated for Camera Operators (700), Special Effects Workers (800), Editors (900), Marketers (1000) and Distribution Channels (1100).

### Initial Script Registration:

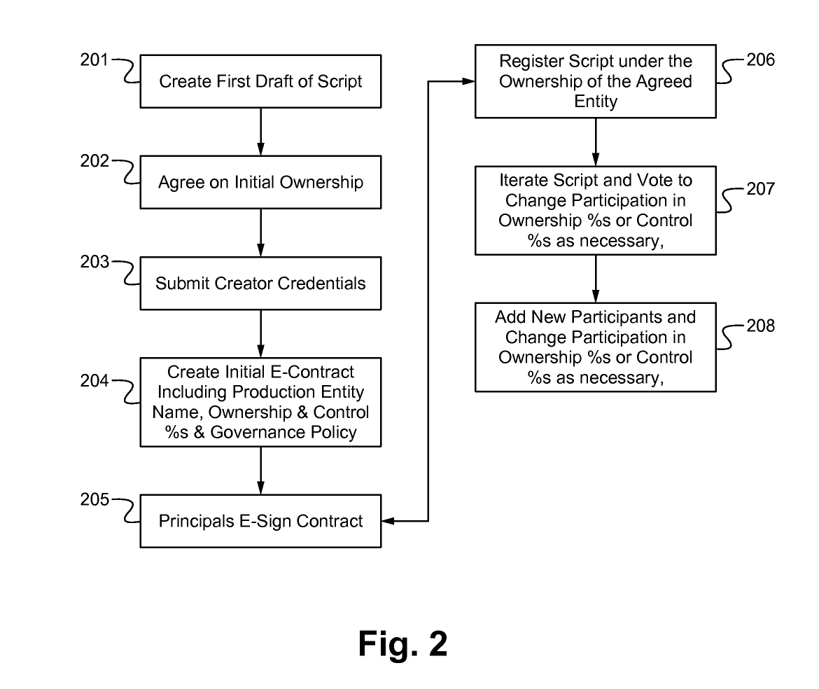

The flows for an Initial Script Registration are able to be seen if FIG. 2 as follows.

First, one or more Creators create the initial instantiation of the script or idea (201). Next they agree on their initial ownership and control percentages (202) and generate their Creator Credentials (203) using accountable robust E-Identities and create an E-Contract that accurately describes the desired contractual relationship. The parties then sign the E-Contract (205) with their Digital Credentials. After the contractual relationship is established and certified, the Script or Idea is Registered under the name of the Agreed Entity (206). The Script or Idea is able to be iterated and degrees of participation and/or control is able to be changed as necessary (207). New participants in the participation or control are able to be added as necessary (208) using the same mechanisms.

### Entity Structure:

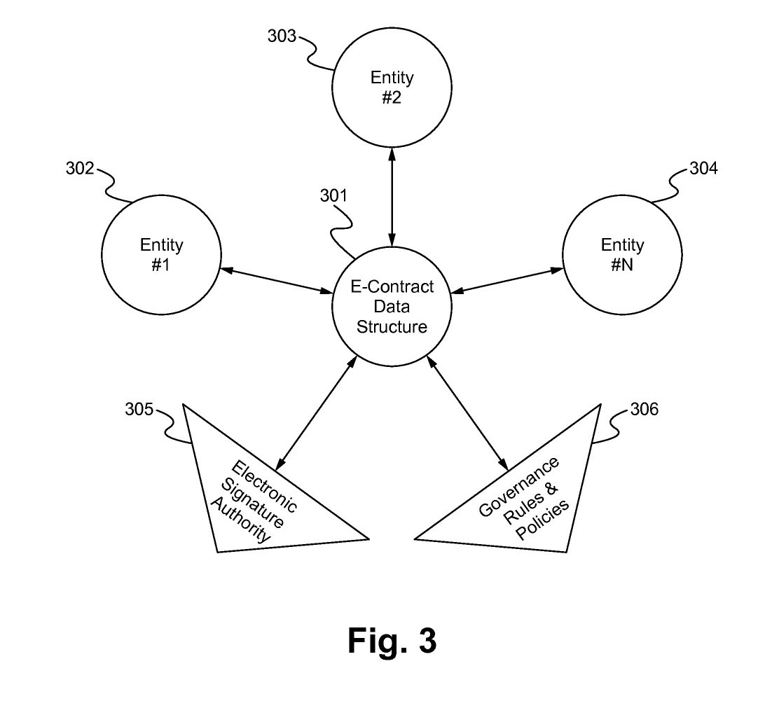

A view of the contractual relationships is able to be seen in FIG. 3. At the center of the process is a data structure known as an E-Contract. This E-Contract (310) codifies, in a binding fashion the relationship among the signing parties (302, 303 and 304). The signatures are guaranteed by and Electronic Signature Authority (301). The E-Contract also codifies and ensures the robustness of the Policies and Rules of Governance (306).

### Electronic Contracts:

The whole preceding section speaks to an electronic representation of the contractual relationships among the parties. The contracts are represented as data structures with fields representing parameters and variables in those fields representing the number associated with the variable. To use as an example the super-majorities as described above, there would be three super-majority fields. Super-majority field one would have a value of 60%, super-majority field two would have a value of 65% and super-majority field three would have a value of 100%. There would also be a default field for simple majority of 50%. Various parameters would be associated with different voting majority variables. Suppose that the decision of Lead Actor is governed by super-majority 2; that would be a parameter of the lead actor selection portion of the data structure that expresses the contractual agreement. When a lead actor is voted upon, the success or failure of a person for that position is subject to the result of the vote. The result of the vote might next trigger an offer price being agreed upon. The offer price up to a certain cap might be subject to only a simple majority vote. Once an offer amount is proposed and agreed by vote, an offer is able to be made to the actor.

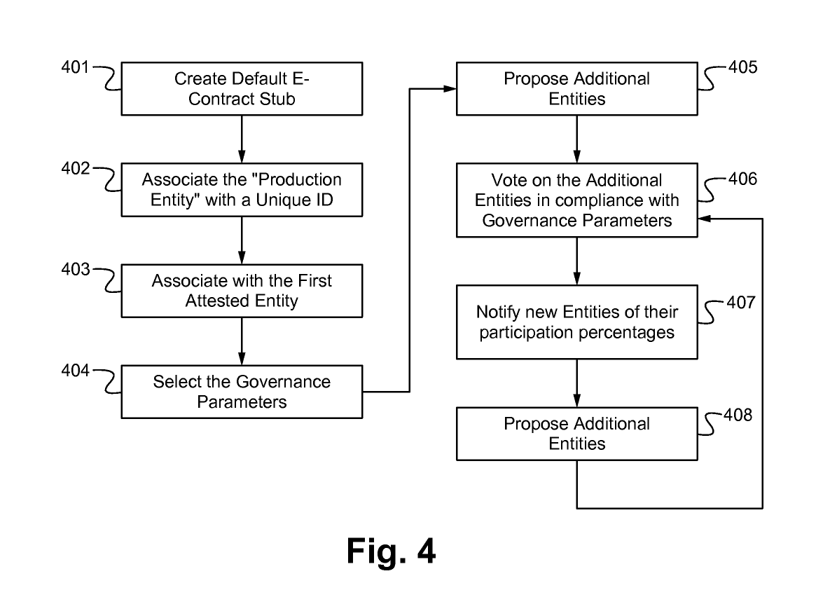

FIG. 4 shows another view of the E-Contract generation and use process. First, an E-Contract Stub (401) is created. This is a data structure into which the rules and parameters and credentials will be placed. Next, a Registered and Unique Production ID is associated with the E-Contract (402). Next, one or more Entities (e.g. persons, partnerships, corporations, others) are associated with the initial Entity (403). Next, Governance Parameters are selected (initial default parameters could be accepted) and are voted upon (404). Other Entities are able to be added to the legal structure (405) and voted upon (406). The entities are then officially notified of the new contractual relationship. New entities (407) are able to be added at any time repeating the loop of proposal (408), Voting and Approval (406) and Notification (407).

The same general processes are able to be used to generate offers to all types of Talent, including the offering of percentages of revenue or control.

Once an entity has been voted the right to participate in control, they will become part of the voting process unless and until there is a new binding vote successfully reverses that right.

### Protecting the Idea:

The creative contributors must have protection of their ideas so that they are able to appropriately participate in the revenue streams that are generated from those ideas. In order to ensure the flexibility of both the creative and development process, when an idea is first generated, the idea will be registered in a robust and secure fashion so that it cannot be tampered with. This is similar to how ideas are today registered with the Writer's Guild (https://www.wgawregistry.org) but more granular and detailed in their electronic representation. Registered material should be in digital form so that it is searchable by machines. Registered material should contain detailed meta-data including: genre (scripted, documentary, reality) and sub-genre (mystery, romantic comedy); owners and controllers and the locations of their agreements and digital signatures, locations and version numbers of all historical versions. Registered ideas will be escrowed for the purpose of forensic investigation. They need not be reviewed by people or parsing algorithms for originality however the provenance of the registration must be uncontestable.

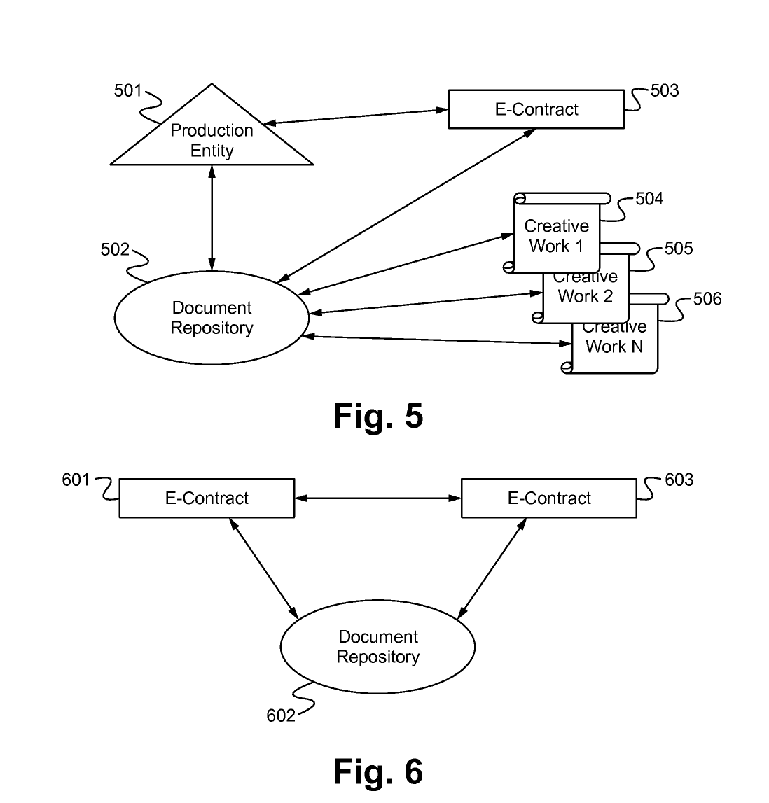

The Idea Registration Flow is able to be seen in FIG. 5 and is as follows.

1) There is a Certified Document Repository (502). This repository is secure and robust and documents or files have clear provenance as attested to by certificates in order to be stored.

2) Associate the Production Entity (501) with the Document Repository (502). When a creative work is deposited in the Repository Associated with the Production Entity, control and ownership parameters are associated with the creative work and codified in the E-Contract (503) of the Production Entity. Each modification of the Creative Work is subject to the Ownership and Control Parameters of the Production Entity as expressed in its E-Contract(s). Ownership and Control Parameters may be changed as per the E-Contract of the Production Entity.

3) Place Creative Works (504, 505, 506) in the Document Repository.

As is able to be seen in FIG. 6, there is an electronic linking between the Document Registry (501) and the Document Repository (502) which is defined and certified by the E-Contract (503).

### The Virtual Agora

The original Agora in ancient Greece was the chief marketplace and the center of civic life. This Virtual Agora is able to be the center of a creative marketplace where ideas are able to flourish as they did between Socrates and Plato in the original Agora.

### Selecting Participants:

The power of crowd creation is that the potential number of collaborators is vast. Because of the requirement of accountability, every registered participant must be associated with a real person or entity.

### Participant Registration:

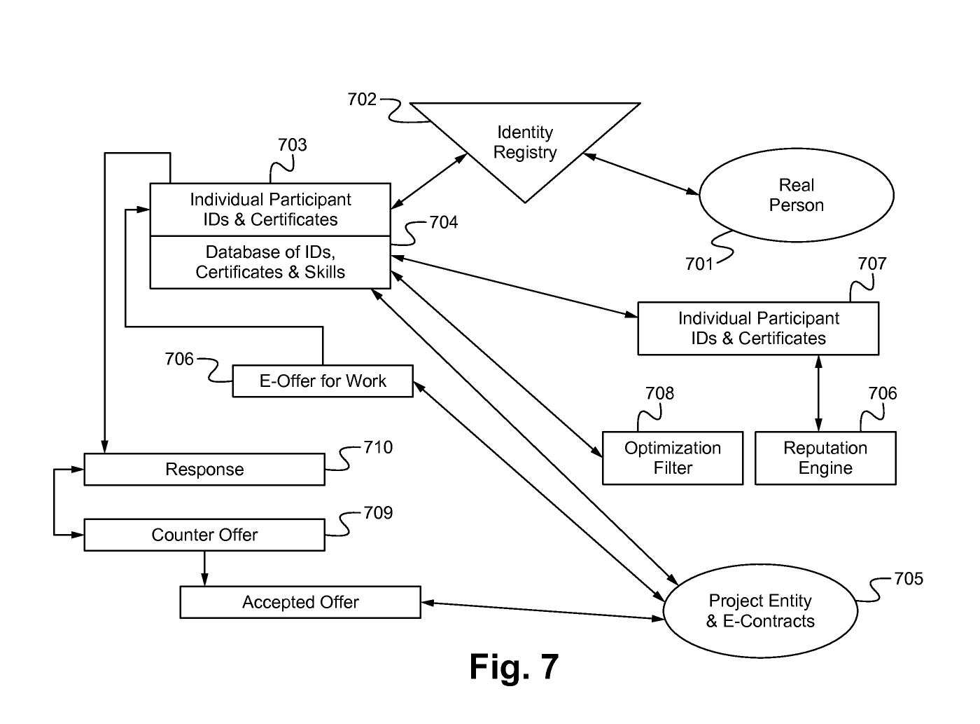

As shown in FIG. 7, each Participant (701) begins by registering to a secure Identity Registry Database (702) with their real identity. Then each participant is given an Identity Certificate (essentially a small E-Contract) that lives in a database (703) along with their Aliases and list of skills (704). The Identity Certificate is able to negotiate on their behalf when negotiating with the Certificates or E-Contracts of other entities. The Participant then populates their Identity Certificate with their list of skills and any aliases they may want to use, and these are able to be updated at any time. Aliases are able to be used to protect famous people and allow them to participate among the masses. These aliases, while opaque to the other registrees, are transparent with respect to legal accountability. The system must keep track of the various aliases so that, for example, a famous writer is able to throw ideas into this Virtual Agora without having them prejudicially judged.

When a Project Entity (e.g. a movie or a TV show) (705) wants to negotiate with an Individual Participant for the use of their skills, they take the following steps:

1) They look up the individual in the database of skills and IDs (704).

2) They may check their reputation using the Reputation Engine (706) which gets its information from the Reputation Information Database (707).

3) They may use an Optimization Filter (708) to limit their choices.

4) They make an offer for work. This could include dates and pay rates. It could include percentages of net or gross.

5) The Individual Participant (through the E-Contract mechanism) responds.

6) There may be an unlimited number of counter offers and responses (709, 710).

7) Ultimately, the offer is either accepted or rejected.

### Granular Reputation Engines:

Having allowed for anonymity, many or most creators will be trying to build their reputation. If others think their writing or editing or directing is good, they should be able to develop a reputation index that is trusted.

There are many axes around which reputation is able to revolve. Participants in the Virtual Agora will receive reputation scores on different axes from different people that they have worked with. Some areas to be indexed might be: promptness, reliability, honesty, ability to solve problems, respect from others and respect for others. There will also be granular details for each discipline. For example, writers might be indexed on: commercial viability, comic dialog, dramatic dialog, scene description, plot development, character development for leading men, character development for leading women, character development for support men. These indices should be seeded initially as an expert system where experts in the field have determined the initial fields of reputation for each discipline. Once the field choices have been seeded, they should be dynamically updated (like a neural network) based on popularity. New fields will be added dynamically and are able to be based on suggestions from the Agora; rarely used characterizations are able to be pruned electronically, and new characterizations are able to have a trial period.

When reviewers rate others, there is no need to select all indices (many surveys require all questions to be answered but that is not the case here). As little as one comment on a participant's capabilities along one axis is still of value.

In addition to reputation based on Individual Participants, there is also reputation based on Awards, Reviews and Anonymous posts, blogs and web sites.

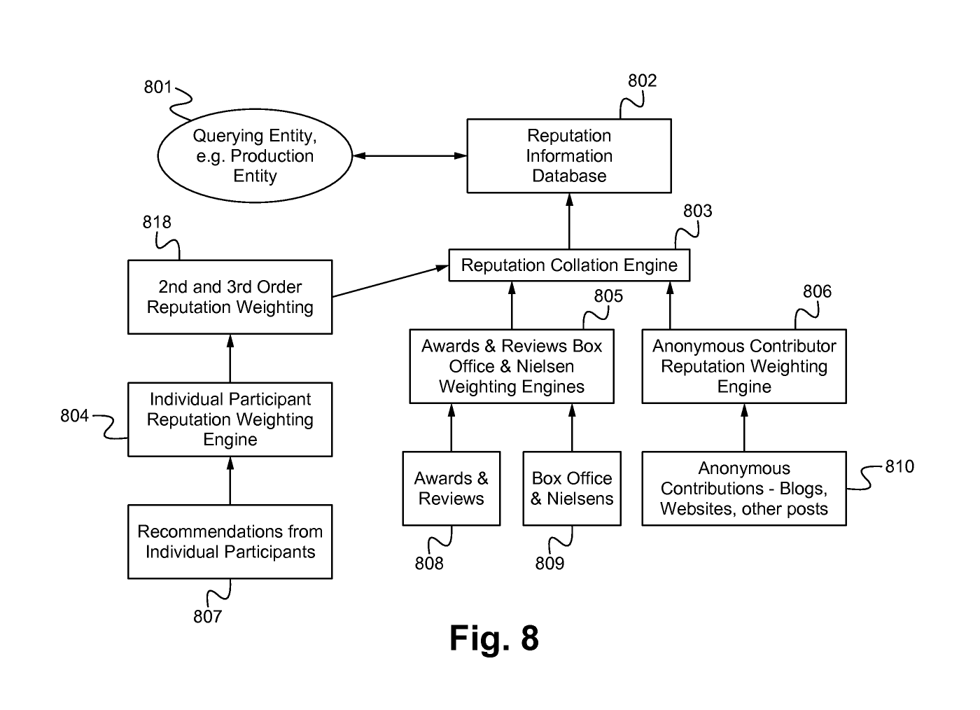

As is able to be seen in FIG. 8, the Querying Entity (typically the Production Entity) (801) queries the Reputation Information Database (802) for reputations of individuals it is interested in. It may ask for the recommendations from a broad set of possible contributors based on parameters such as class, location reputation and/or historical price. Reputations are collected from multiple sources. There are the explicit recommendations from the Individual Participants in the ecosystem (807) (e.g., people who have worked with the individual in question or have opinions about their work). There is the collation of Awards, Reviews (808) and Box Office success or Nielsen Ratings (809), and there are Anonymous Contributions (810) from blogs, websites and other posts.

One additional factor to be included in the creation of the reputation indices is the weighting of the value of each recommendation (804, 805, 806). For example, if a reviewer, such as, a director, has a historical box office of multiple successful movies, their recommendation on the commercial viability of a writer would be weighted more heavily than an unknown director. The reviewers are able to not only be rated on publicly available data like box office success but also on historical accuracy. For example, if a person who has reviewed hundreds of actors gives 10 new actors a high rating, and those actors go on to be successful, that person's reviewer rating, with regard to selection of actors, will be high.

Individual reviews are able to be read. Individual reviewers may be anonymous to the searcher but not anonymous to the system so that the reader is able to value the reviewer based on their Reputation. Because of the de-referencing of the Reputations (818) and weighting based on degrees of separation, a reviewer's veracity is also generated. For example, if the user is looking for a Camera Operator who is particularly good at long shots, the user will start with those Camera Operators, among all the camera operators in the system (not just those who are available or local) who have been noted as good at long shots (the pool of Camera Operators will be smaller because many recommendations may be silent on that particular aspect) and see which of those have recommended Camera Operators in the pool of possible Camera Operators. This is able to be done expanding by a couple of degrees—that is not just those who have been recommended by people known to be good at long shots but also people who have been recommended by people who were recommended by people who are known to be good at long shots (2nd degree of separation). This would be weighted slightly lower than those who have recommended directly. Reviewers who are a 3rd degree of separation away are able to also be factored into the ratings of the Camera Operators but would be weighted less than those reviewers who are separated by one degree or two degrees.

Veracity, as well as other aspects of the methods described herein, is able to be used with respect to other entities such as journalists. For example, the rate of accuracy of journalists in publications or other media including analyzing the historical accuracy of their predictions is able to be utilized.

Different kinds of content use different creative environments and are broken down, below. Sub-genres are also possible.

### The Scripted Agora:

The history of multiple writers working on a script is long and storied. Often, one writer begins a project and others finish it. Using the control mechanisms above, this is able to still happen. If, for example, the studio has control, they are able to act unilaterally. If they have 40% control and the director has 15% control, they could only do this if the Studio and Director were in agreement. This is similar to how things have been done (though this is more formally defined). However, there are new mechanisms that are able to be used based on the scale of the Virtual Agora. For example, a user has a movie written, but the user does not think the opening is dynamic enough. The user could send out a bid for writing the opening 5 minutes and offer 5% of the writing ownership and a credit that read, “Opening sequence written by . . . ” The user could then ask the community to read the new openings and score them. The user could factor the value of the rating based, partly, on if the reviewer says they have read the whole script or only the new opening. The user could then read the most highly reviewed and choose one or not. All the openings would be kept in the network so that if the user tried to steal someone else's idea, they would have the forensic evidence to support a claim.

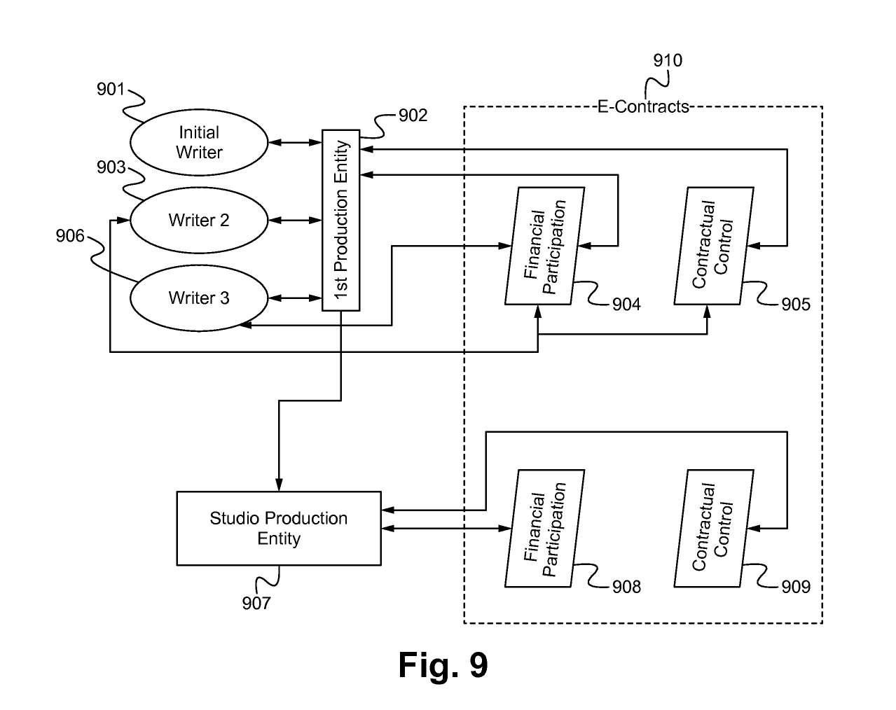

To help clarify the mechanism, a walk through is described herein of one specific scenario as outlined in FIG. 9. Mary is a writer (901) and begins working on a script. Mary creates or already has a Production Entity (902) governed by an E-Contract (910). Mary's initial rights are 100% Ownership (904) and 100% Control (905). Mary likes the general direction but as she has never written an action script before, so she asks John (903) to work on it with her. Because she trusts John and knows he has a lot of experience selling scripts, she agrees to give him an equal share of both ownership and control. Because the bylaws of Mary's Production Entity (902) as expressed in her E-Contract (910) require a super majority of 60% in order to change ownership or control, she knows that they will both have to agree in order to change ownership or control. Mary forms an E-Offer and sends it to John who accepts and signs the acceptance with his digital signature. After working on it for a while, they realize they would like a bit more polish so they bring in a third writer, Bernie (903). They agree to give Bernie a 10% Revenue Share of the Writer's portion of the revenue from the final movie including advances, subject to further dilution if other writers are brought in. Mary and John put together an E-Offer reflecting that participation, vote on it electronically, and the offer is sent to Bernie who accepts it by signing with his Digital Signature. It is stored in the E-Contract (910) as a change to the Financial Participation (904).

Mary and John then go to Amy, a studio executive they know and show her the script. Amy likes the script and instructs her lawyers to make an offer. The Studio (907) makes an E-Offer to Mary's Production Entity. Mary and John want the right to approve the Director and make a counter offer. The Studio wants the right to terminate if they cannot agree on the initial choice of Director with Mary and send their own Counter E-Offer. Mary and John want to accept. The vote electronically to accept the offer meeting the 60% supermajority required for such decisions and Mary's Production Entity send the signed response to the Studio. Note that though the votes were signed by Mary and John, the acceptance was signed by the First Production Entity. The First Production Entity is now a sub-contractor to the Studio Production Entity and the rights of the First Production Entity are now codified in the Studio Production Entities E-Contract with the First Production Entity (908 & 909).

### The Documentary Agora:

In the first phase, the Documentary Agora is not very different from other Agoras—people write bits of an outline or proposal instead of a script, and they share in the ownership. This is analogous to the way FIG. 9 works and is able to be applied in a similar fashion. The Documentary Agora, however, creates some new and interesting possibilities. Camera operators have their own Agora as people hired to film events, people or others. However, in the Documentary Agora, you may have lots of disparate bits of film created independently by separate people using their own equipment to capture some event. For example, suppose a user wanted to document Times Square on New Year's Eve? The user could put a call out to the Agora for people to film using whatever device they have (perhaps including many mobile phones) and to submit it to be curated by the crowds. People could rate the various clips. Using audio fingerprinting, all the videos could be synchronized. Then the video could be assembled using algorithms or by an editor who's decisions were informed by the ratings of the different clips. This could be done for any event from a rock concert to a demonstration in Kiev's central square. These documentaries might be made of clips from people who agreed to allow their videos to be used for free (phone videos from participants or audience members) mixed with videos from professional cameramen who submitted their videos subject to compensation. All the compensation could be pre-arranged based on click licenses that were digitally signed.

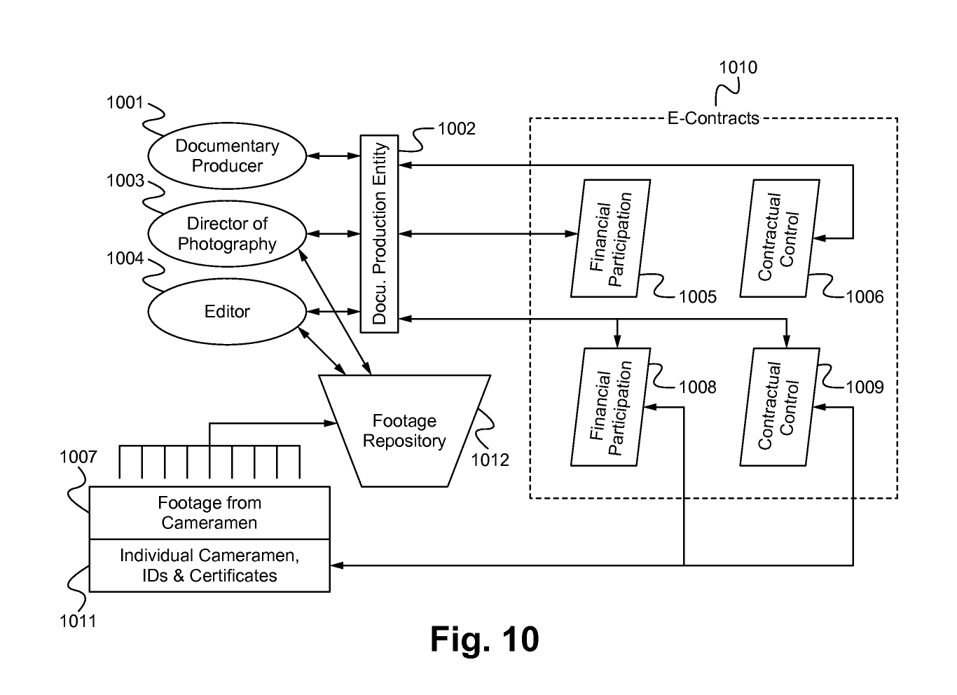

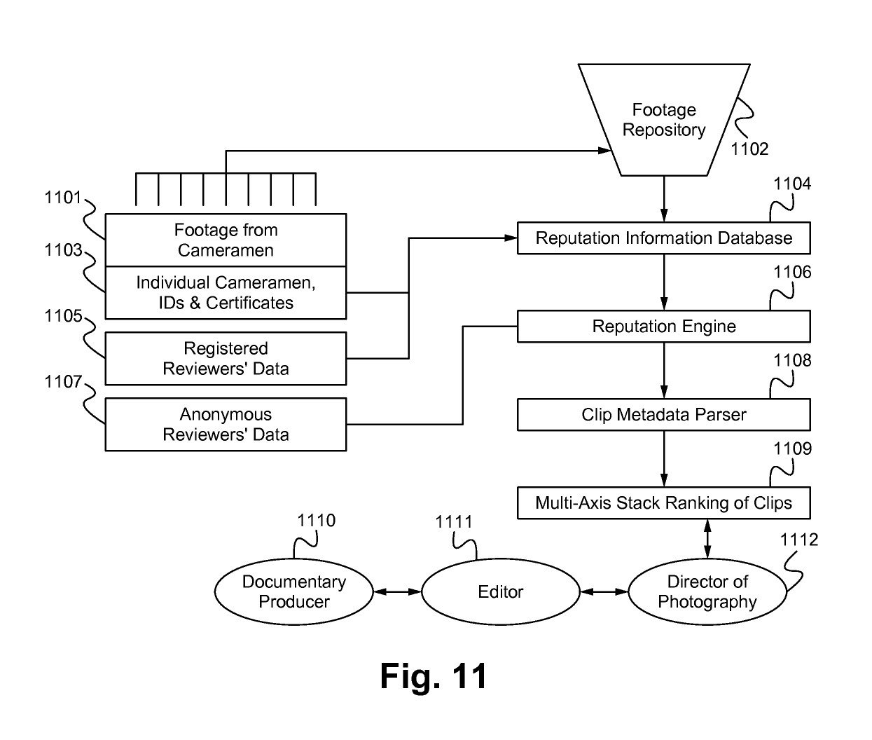

To help clarify the mechanism, one specific scenario is outlined in FIG. 10. For example, Christos and Marios have been to many Greek Festivals in the United States and want to document the food and dancing across the country. They go to a Production Entity creation web site and fill out the forms to create the “Greek Festivals Production Company” (Docu. Production Entity, 1002). They select the bylaws from a set of preconfigured possibilities; they pay the partnership fees and use their digital credentials to sign the documents. They do not know exactly what the form the documentary will take and are open to any possibilities, so they find an experienced Director of Photographer (1003) and an experienced Editor (1004) and sign E-Contracts with both of them for some Financial Participation (1005). For Control (1006) over the process, they agree that the DP (Director of Photography) gets 33% control over the selection of the footage, and the Editor gets 33% control over the way it is edited.

In order to find the best footage, the DP puts out a request to the Cameraman's Agora (1011) for cameramen who have high-quality footage (1007) of Greek festivals across the United States. Cameramen, who are interested, sign an E-Contract stipulating their payment participation (1008)—a small % based on the amount of footage used; their credit (1009)—e.g., as a cameraman if, for example, more than 1 minute of footage is used; and giving the production entity the rights to use the footage. There are a few cameramen who have a lot of respect in the industry, and they propose, to the DP, a special rate including special credit and higher remuneration. Two of these offers are selected.

There are now thousands of hours of footage to be sorted through. First, in addition to basic metadata such as time, date and location, each cameraman should add some metadata to the footage. This is able to be unstructured text that is able to be parsed by intelligent text parsing engines. When possible the data should also include things such as the name of the event filmed and the names of the participants if available.

### The Footage Repository:

An issue is how are we to sort through this huge mass of footage? To clarify the series of possible steps, FIG. 11, the Footage Repository, is shown.

The footage is posted to a private area called the Footage Repository (1102) which is under the control of the Documentary Production Entity. Though the footage itself could be on servers anywhere as provided by cloud based hosting services, the control of access to the footage itself and the associated metadata requires permissions—typically certificates as provided by the E-Contracts (1011). The individual cameramen are given access to the footage they have posted, but once they have completed the transaction of licensing to the Production Entity, they may no longer control the copy in the Footage Repository which is now under the control of the Documentary Production Entity. In some embodiments, the Footage Repository is not under control of the Production Entity but rather, the Production Entity is able to exercise control. For example, the files are stored in a commercial cloud, but they are encrypted, and when someone wants access to footage, that person has to present his/her credentials, and then access is granted.

The participants of the Agora (1103, 1105) are used to curate the content. This “Crowd Curation” functions on multiple levels. First, there are multiple axes: 1) How on topic is it? 2) How good are the performances in the video? A great speech with less than optimal lighting or color balance is better than a boring speech that is well lit. 3) How is the quality of the shot (light, composition, contrast, focus)? This could be multiple different choices or it could be one (probably, one with sub-choices if the reviewers want to drill down). 4) How is the audio?

The value of each reviewer is rated. High on the list are the cameramen who shot the footage. They know what the expectations are, they know about footage, and they know the subject. The value of other recommenders is weighted based on their expertise and success. Actors are more highly rated when it comes to the quality of individual performances. Directors and Producers are more highly rated when it comes to overall value to the project. Audio engineers are more highly rated when it comes to sound quality. The general audience of Anonymous Reviewers (1107) is best when it comes to guessing what will be a popular scene. In general, but particularly with regard to the Anonymous Reviewers, passive data is able to be used as well as the explicit review data listed above. For example, if a clip is not watched all the way through, it would be rated lower than one that was watched all the way through. Also clips that are watched multiple times are rated higher. If a section of a clip was watched multiple times, that section is able to be flagged and rated higher than if it was not.

Returning to the Identified reviewers, their reputation relevant metadata (1105) is placed in the Reputation Information Database (1104). This database feeds the Reputation Engine (1106) which is also fed by the Anonymous Reviewer Data (1107). Each individual in each sub-group is individually rated based on their historic accuracy. So for example, if a reviewer used the term riveting when referring to a performance, and in all those cases the performance made the final cut, that means that their reputation with regard to performance quality is high (and vice versa). Additionally, if a reviewer (registered as opposed to anonymous) has good credits, they are rated higher. For example, a cameraman who has worked on multiple academy award winning films is naturally rated higher than someone who has never worked professionally. Also if someone has awards (e.g., nominations for a Golden Globe), that increases their reputation index. Finally, if someone has been mentioned positively in blog posts or published reviews, that also increases their reputation index—more for a major review like in a trade magazine and less for a casual blogger.

When the Director of Photography (1112) or others with the appropriate permissions log in to the Footage repository, they do it through a dashboard that is informed by a Multi-Axis Stack Ranking of Clips (1109) which is in turn informed by Clip Metadata Parser (1108) and the Reputation Engine (1106) which all use data captured from the Reputation Information Database (1104) and the Footage repository (1102). The Multi-Axis Stack Ranking of Clips module ranks the clips based on how high they are on different axes. For example, if a user is looking for an emotional moment with good audio that is a close up on a face, those parameters could be raised on the Ranking Dashboard and the proximity by date and time to the previous clip might be de-prioritized. However, for another clip, such as further shots of the crowd at a specific event, the audio might be unimportant (different audio could be used later) but the time of day (e.g. brightness, sun position) could be raised higher in the Ranking Dashboard.

### The Reality Agora:

Reality shows are typically based on a concept, frequently with “talent” (the personalities or actors) attached. In the Reality Agora, concepts could be posted in an “open call” to personalities. For example, chefs might apply to a new concept for a cooking show. The community might express their opinions on the concept and the talent and the combination. Based on the perceived value of the talent, an offer might be made. It could be a financial guarantee or a percentage of participation or both or neither. Once the concept and the talent have established their legal relationship, the new talent-attached proposal is able to be shopped around or is able to be filmed in a sizzle or demonstration reel that is able to then be put out to the community for review or sent directly to distributors for further negotiation.

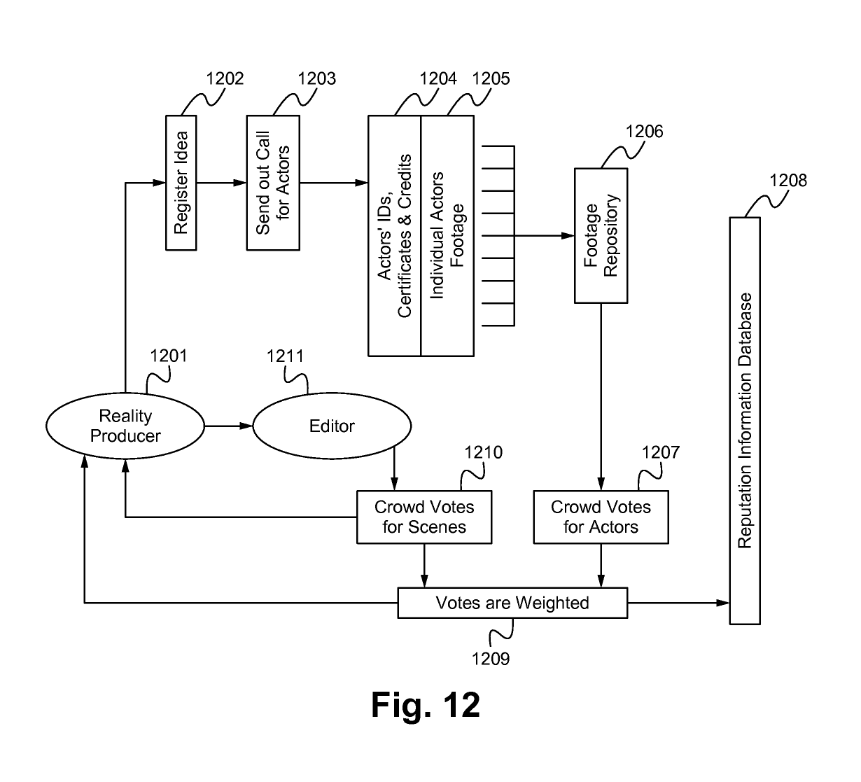

A more social approach is shown in FIG. 12 (Reality Agora). In this example, the majority of the show is able to be created in a network-connected social environment. First, the Reality Producer (1201) registers her idea (1202) and sends out a call for actors (1203). Actors read the proposal (or whatever portion of the proposal is made public) and register with the project (1204) as was demonstrated previously in FIG. 7. By signing their registration they agree to a click license (E-Contract). The Actors then upload their footage to the Footage repository (1206) as test footage (that is, they may not necessarily have the rights to use this footage commercially). Now the set of registered industry users (actors, cameramen, writers) and optionally the additional set of all registered users (e.g. not in the industry but like to watch and vote) express their opinions rating the footage of the various actors (1207). The opinions are weighted using the Reputation Information Database (1208) and are stack ranked and sent to the Producer (1201).

This process is able to be used to find potential Reality Actors, and they are able to be contacted, and E-Offers are able to be made.

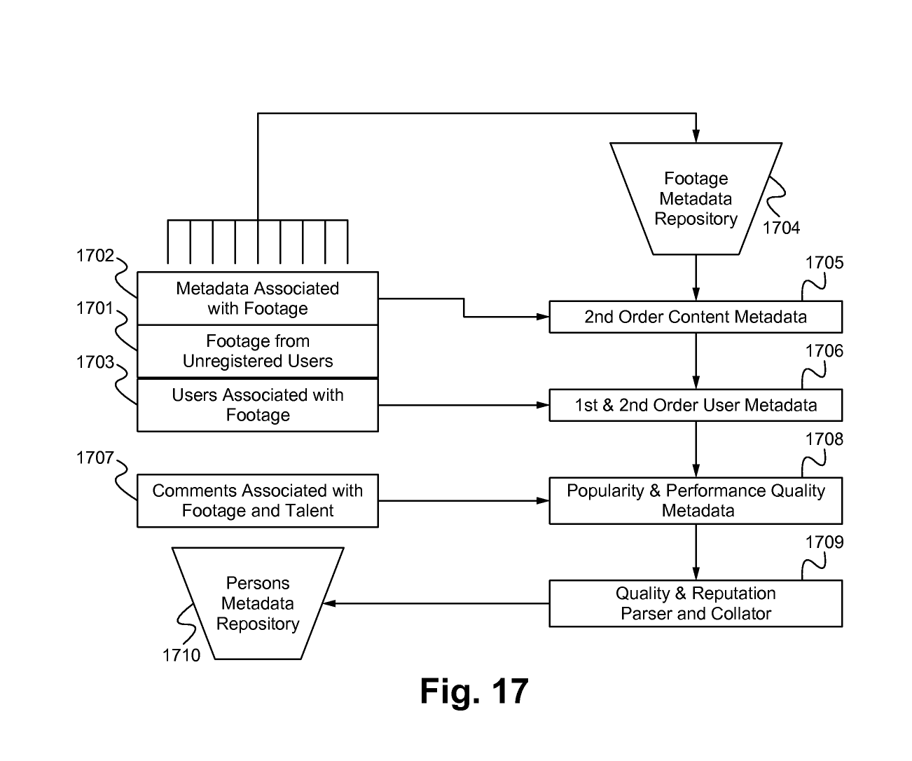

Using a different approach, the Actors and scenes selected by the crowd, and the Producer is able to be sent to an Editor (1211) who, in collaboration with the producer and other professionals (e.g. Reality Writers) are able to put together one or more vignettes that are then sent back into the Reality Agora where the crowd (1212) votes on Scenes. These scenes could also be sent to an Editor Agora where as in FIG. 17, a crowd of Editors could do different edits, and the crowd could vote on them. This whole process is able to be an iterative loop where different versions keep going back to the crowd and to Editors for further iterations until the producer feels it is ready for publication. Alternatively, the content could stay in the loop indefinitely drawing viewership and advertising dollars to multiple different versions.

### The Agency Agora:

In today's world of filmed entertainment, talent of all kinds is represented by an Agent or an Agency. How does an Agency find the talent to represent? Today, it is typically by word of mouth. Agencies cannot take unsolicited tapes of actors, writers, or directors because they would be inundated and be unable to cut through the noise. However, if an agency had access to the ratings of the talent pool as measured by their peers and by others of some repute; they could make better informed decisions. As noted above, the value of each recommendation could be weighted based on the track record of the reviewer. So, for example a successful Director or Show-Runner's opinion of an actor might be given a higher value than a Cameraman who had never worked on a professional project.

An Agency might also have a dashboard where they could adjust the parameters, for example, weighting professional actors more heavily in one view and directors of photography in another view. They might weight comedy writers more heavily when looking for one kind of actor and drama writers more when looking for another kind of actor.

To clarify the way this works, refer to Diagram 13. The process begins with an Agency (1301). An Agency is always looking for new and established talent. There are two distinct pools of talent. 1) Professional Talent (1302): those members of the community who have worked on professional films and videos and are rated by their peers and by their credits. 2) Amateur Talent (1303): these are people who either a) want to become professional and have not yet had the opportunity or b) pure amateurs who do this simply for the personal enjoyment and the pleasure of their social network. The reputation engines for the two groups of talent work differently. The professional Reputation Engine works as it does in FIG. 8. The Amateur recommendation engine works a bit differently. Because the Amateur Reputation Engine does not have the breadth of accountability of the professional reviewers it works mostly by inference. If scenes that are paused on or repeated have close ups, that implies that the actor in the scene is better. Close ups are more about the actors. Long dialog is more about the writer. Long shots are more about the cinematography. In general, for the amateur, popularity is the highest value.

### The Legal Agora:

For many arrangements in the Agora, there will be an electronic offer made, and a participant is able to either accept or reject. However, sometimes more detail and nuance is required. There can not only be recommendations for both sides of a negotiation, but there are able to also be recommendations for legal counsel. Counsel could be paid directly (billed with or without a retainer) or counsel could agree to a revenue participation for a portion of the clients revenue or some combination of both.

There is a broad range of appropriate legal effort required depending on the deal. Just like today, there are able to be all ranges of effort required in negotiation and all levels of expertise and negotiating ability. Lawyers in the Legal Agora should be transparent in both their pricing and their capabilities.

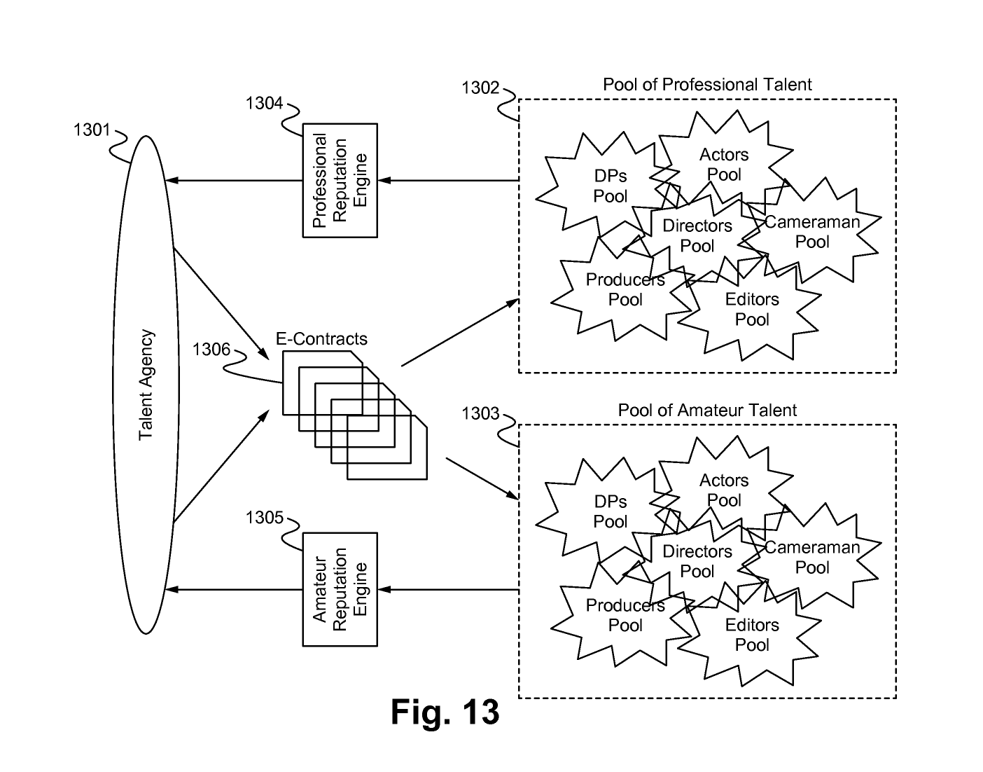

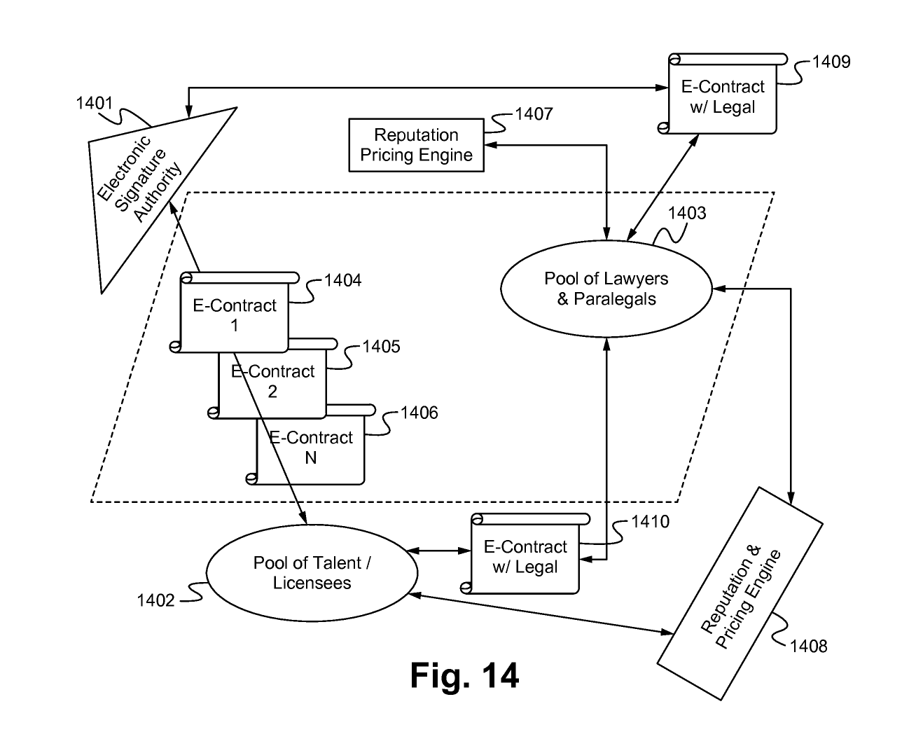

FIG. 14 shows the steps required to take advantage of the Legal Agora. A Production Entity (1401) wants to utilize some talent (e.g. an Actor, Director, Cameraman) from the various pools of talent (1402). They need a Lawyer (1403) to negotiate on their behalf and so, using the Reputation Engine (1407) they choose one. The Reputation and Pricing Engine works similarly to the Reputation Engines in FIGS. 7, 8, 11, 12 and 13. Included in this diagram is also the concept of adding Pricing information to the engine. This is able to be found in the Metadata associated with any negotiating entity and either the type of pricing (from pro-bono to hourly to a percentage of revenue) or the amounts are able to be exposed. Once a Lawyer is chosen, they both digitally sign the E-Contract (1409). A mirror of that behavior happens between the Talent (1402) and their Legal Counsel (1403) using the Reputation and pricing Engine (1408) and signing an E-Contract (1410). The Lawyers representing the Talent and the Production Entity are able to negotiate their E-Contracts (1404, 1405, 1406).

### The Filming:

Producers, Associate Producers, Executive Producers are all part of the business and coordination portion of making a commercial film or TV show.

Filming is generally in a hierarchy. In the US, at least, the technical crew is subordinate to the Director of Photography (DP) who, along with and next to the Director, has the final word on all decisions related to both lighting and framing, color and tone. The DP selects the Camera Operators. Camera Operators sometime evolve into Directors of Photography. In the Agora, Camera Operators (as in the real world) might accept less money for the opportunity to be a DP to advance her career. However, in the Agora, Camera Operators might have the opportunity to select low budget films to work on and find opportunities to which they would never have been exposed in a purely manual world. When a DP is looking for Camera Operators, they could use the Agora and recommendation and filtering to review the work of hundreds or thousands of Camera Operators to narrow the field.

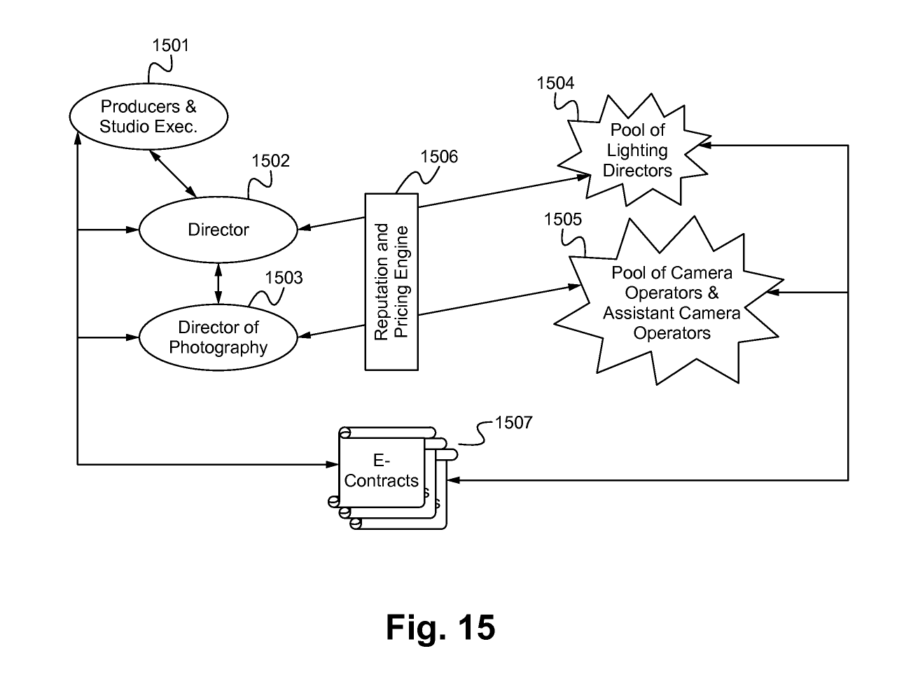

FIG. 15 demonstrates how this process is able to work. For this example, it is assumed the Producers/Studio Executives (1501) have already selected a Director (1502) and the Director has selected a Director of Photography (DP). They could have used the Agora and the Reputation Engine for that process. The DP now leads the process for finding Camera Operators (1505). The DP queries the Camera Operator's Agora looking for Camera Operators available on the proposed filming dates. The DP will optimize the search by setting parameters to be used by the Reputation Engine like a minimal score on the reliability index, a minimal score on the experience index (perhaps separate numbers for Film and for TV and for Internet), perhaps someone who has worked with some of the actors expected, high scores on filming in populous cities. Perhaps the Actors, the Director and the Producers are also entered hierarchically with the most important ones at the top to see what the rating would be based on their Reputation Score of the Camera Operator. Similar to FIG. 8, Reputations and Recommendations are able to be de-referenced by 1, 2, 3 or more degrees of separation. Reviewers who are 3 degrees of separation away will be weighted lower than those who are 2 degrees away and higher than those who are 4 degrees away.

In a similar factor, the Director (along with the DP) selects the Lighting Director from the Pool of Lighting Directors (1504) using the Reputation Engine (1506).

Just as there is a hierarchy for DPs and Camera Operators so there is also a hierarchy for Directors Assistant Directors (ADs), 2nd ADs, 3rd ADs, Production Assistants, Line Producers. These are able to all be selected or placed in a pool of possible choices using the mechanisms listed above.

### The Special Effects:

Special Effects are becoming easier and easier to provide. Initially, effects were done manually (hand painting on top of frames of film). Gradually it has become more automated but still usually requires a large infrastructure where effects workers have to be proximate to all the processing power and effects tools. This technology will move to the cloud and with it, the requirements of collocation will go away. Once we have an environment where workers, time spent working and location of resources are all fungible, it will be possible to farm out effects as “piece work.” We saw above where recommendation and reputation are important for choosing writers and how added transparency creates accountability. The same thing will happen to Special Effects workers. For example, there is a software program that specializes in removing wires from scenes where they were used to suspend actors. Special Effects workers would list this as a specialty that they have, and the recommendation engine would advise who the best hires were. People are able to break into the field by low pricing and money-back guarantees. Other more experiences workers might guarantee fast turn-around or the ability to work in higher resolutions or on trickier scenes.

In the hierarchy of Special Effects, there is a Special Effects Coordinator who typically manages all the workers and software. They might logically be the person to take advantage of the Effects Agora but they might be chosen by the Director or Producer using the same Agora just focused on management and coordination skills and experience as well as the other metrics.

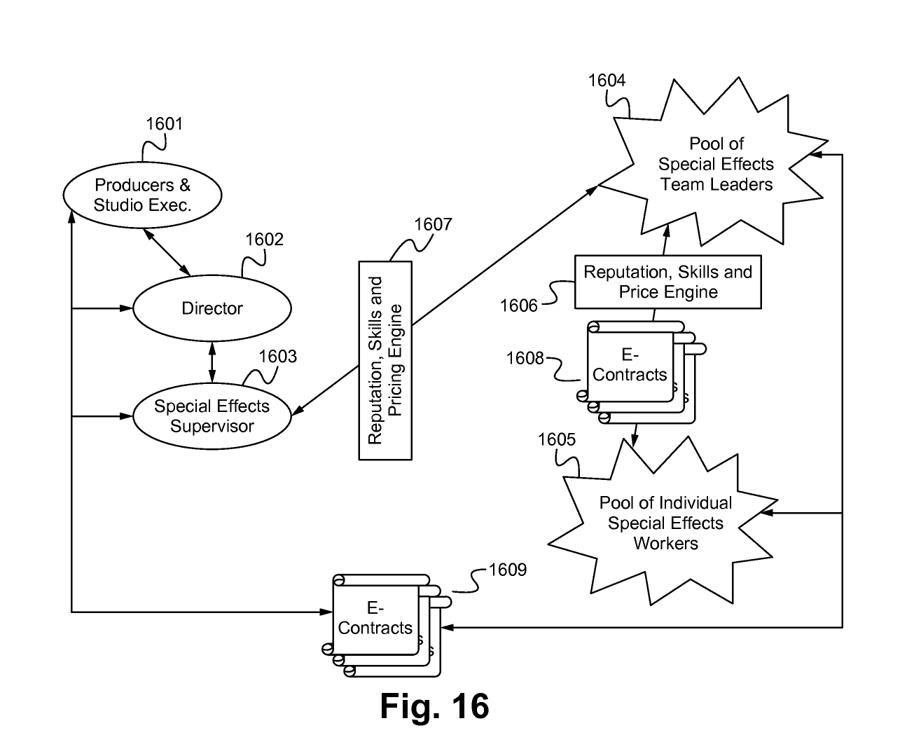

FIG. 16 illustrates the Special Effects Agora. The Director (1602), possibly in coordination with the Producers and/or Studio Executives (1601), chooses a Special Effects Supervisor (1603). This process could be effectuated using E-Contracts, Reputation/Recommendation Engines and the same kind of Agora possibilities as with other workers on the production. In FIG. 16, Visual Effects are the focus. As with other groups of workers, this is somewhat hierarchical. Though there are many possible hierarchies, the method described herein does not specify the hierarchy and is able to support any kind of hierarchy; the one listed here is just for purposes of example. Typically, a Visual Effects (VFX) Supervisor might work with a number of Facility Computer Graphics (CG) Supervisors and Facility VFX Supervisors. They will, in turn work with Production Managers and Production Coordinators (1604) who will, with them also work with Lead Technical Directors, Technical Directors, Lead Compositors and Compositors (1605). As the hierarchies are not fixed, the system should be very flexible with regard to the capabilities of VFX workers.

Additionally, there is another axis on which this pivots and that it which teams have worked together. The Reputation, Skills and Pricing Engines (1606 & 1607) should track, in addition to the lists of skills, the historical record of what other workers each worker has worked with and the dates of those engagements. This is able to then be used to help in assembling teams and even, based on the outcomes of the individual projects, be used to avoid certain combinations.

There is one more axis on which this pivots, and that is pricing of worker's salaries. There is a set of expected salary levels that is able to be informed by locale (e.g., Rajasthan might be cheaper than Manhattan) and by years of experience, type of experience. Additionally, if the worker has a history working for this Production Entity, there are able to be historic salary levels.

As with other kinds of workers, salaries and terms of employment are able to be negotiated manually, but they are able to also be negotiated or finalized using E-Contracts (which being part of the same system would easily feed back into the Reputation, Skills and Pricing Engines (1606 & 1607).

### The Editing:

Consumer editing tools are already quite robust and will soon surpass the professional tools of the last decade. How does editing benefit from the “Agora Effect?” Certainly, it will be important for the Director to be in close proximity to the Editor. Physical proximity will be partially replaced by virtual proximity. Certainly, edits will be cached in the cloud in real time and Directors will have access to them in real time. Also editing is subject to piece work just as Effects are subject to piece work. There is nothing stopping an Editor from farming out a car race to one or more Editors who the reputation engine says are quite good at car races. The Senior Editor could then cut them together. These editors could all be paid by the hour (the software monitoring their time), or they could be paid on “amount of frames used” basis where they get paid based on how many frames are actually used in the final cut. Perhaps, their frames have to be purchased within a prescribed period (e.g. 48 hours), and the Senior Editor might “buy” multiple versions and finalize the decision later.

It should be reasonably clear how to, taking into consideration the language above about how an Editing Arora would work, map the Reputation/Recommendation Engines, E-Contracts and the general principles of the various Agoras above (Writing, Filming, Visual Effects) to an Editing Agora, and so no Editing-specific diagram is needed.

### The Amateur Agora:

Many video-based titles are created today by amateurs. Some are short clips of their children or pets or pranks. However, as the tools of creation become democratized, higher and higher quality content will be created by non-professionals. Millions of hours of video are being created every hour. Most of this video is of limited interest to most consumers. Occasionally, a video becomes very popular having millions of views in a very short period of time. This viral recommendation effect is currently applied to short snack-sized media but as the quality improves, longer forms will also become popular.

FIG. 17 shows how data about media and participants both on the creation and consumption side is able to be gathered. Looking at the cumulative collection of all the video footage that is posted on the web, there are many sources, and there will be more. Currently there are YouTube, Dailymotion, Metacafe, Vimeo, Youku and dozens of other smaller providers. These will only increase in number and scale. 1701 represents the collective footage of all crawlable video services. The actual video is not collected, only the references (URLs) to it. 1702 is the metadata associated with those videos. Some sites collect more data than others and some sites allow 3rd party access to more data than others. Also some sites could have business relationships with third parties to allow greater access to metadata. The data in 1702 is associated with the video represented by 1701. All of this data (the URLs in 1701 and the additional data in 1702) is stored in a Footage Metadata repository. 2nd order metadata (1705) like the order of videos watched or the profiles of the people watching the videos or the data associated with other content that is similarly tagged is collected. Next, 1st and 2nd order User Data (1706) is added to the mix. This includes data such as: what videos are my friends watching, what videos are the friends of my friends watching, what are the comments about the videos (e.g. she was so riveting I couldn't take my eyes off of her, or I am very impressed with the cinematography or I hate the lighting or the costumes were awesome). This data is collected from social networks, blog posts and other public fora (1707). This is then added to the Popularity and Performance Quality Metadata (1708) along with the basic usage like number of views, location of viewers, time of day of viewing, how much was each video viewed (e.g., did many people stop after 1 minute, how many people watched it multiple times, what part of the video was watched most often).

This data is then all collected and stored in a scalable parsable form (1710) so that the talent acquisition entities (Directors, Production Companies, Editors) are able to use this data to search for talent.

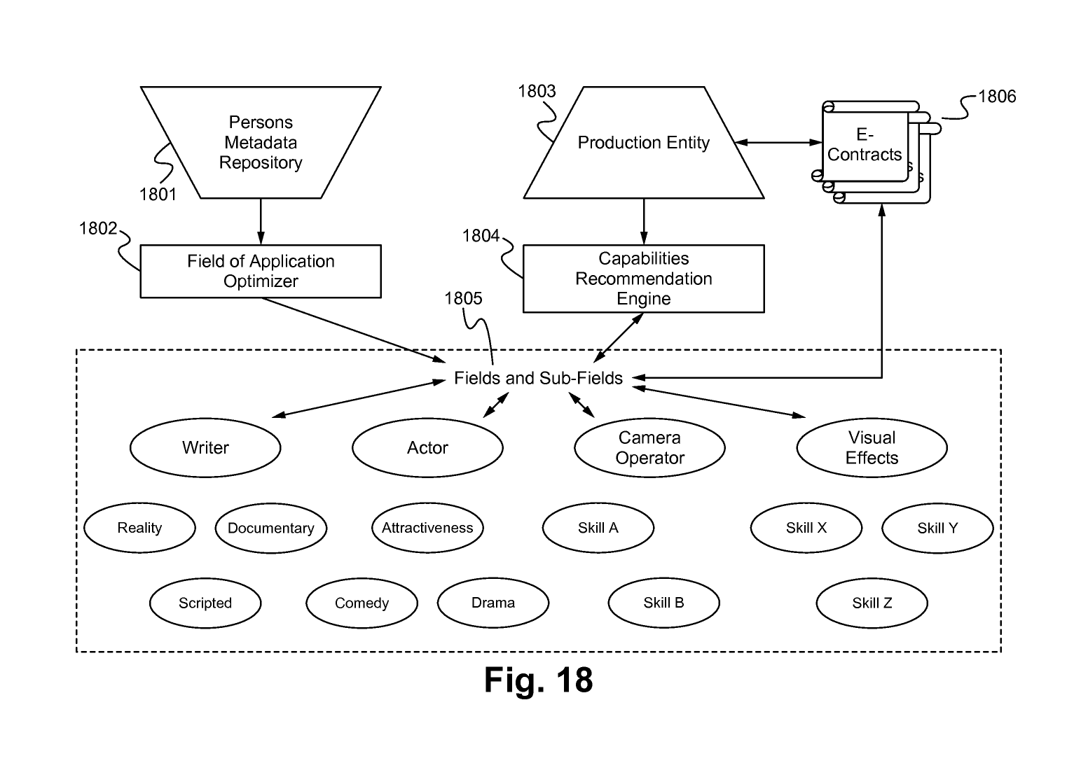

FIG. 18 shows how the Amateur Agora is able to be used for Finding Talent. The figure begins with the Person's Metadata Repository (1801) which was carried over from FIG. 17. This contains all the metadata about potential talent which was gleaned from the Amateur Agora. This metadata is acted on by the Field of Application Optimizer (1802) which takes all of the metadata and associates it with its relevance to selected tasks. For example if social networks indicate that a particular video was very well written and indications are also that the writer was Individual A, then Individual A is associated with the Writer Field and given the appropriate reputation. If it is a Comedy, it would be particularly associated with the subfield of Comedy. Note that the Fields and Sub-fields (1805) are not shown here to be exhaustive but are representative of some of the Fields and Sub-Fields.

When a Production Entity (1803) is looking for a certain type of talent (e.g. a writer or a Director of Photography), they make their request through the Capabilities Recommendation Engine (1804) which parses the Fields and Sub-Fields for talent which has been tagged with the metadata from the Field of Application Optimizer. The Capabilities Recommendation Engine then returns relevant choices for talent to the Production Entity which is able to then propose E-Offers to the Talent from their store of E-Contracts (1806).

Based on the monitoring of granular consumption behavior many things are able to be learned.

### FOR EXAMPLE

### Bell Weather Consumers

Popular fads and media often have a curve of adoption. They may not be popular when they are first released but they become more popular as time goes on. When there is a large set of consumers whose consumption choices are tracked over time, there will be some consumers who are early adopters. Imagine that “Show A” becomes popular in December even though it was released in September. By seeing which consumers were watching this show in September, a class of consumers has been created who may have been predictors of success. A consumer watching a show early does not tell much but thousands of consumers (out of the millions or billions of consumers followed) who consistently watch a particular class of video assets early could be an accurate predictor. This will likely be optimized by granular tracking so, for example, there might be 3,000 comedian predictors who have watched comedians numerous times 3 months before they became popular. The unknown comedians these Comedian Predictors are just beginning to watch today have a significantly higher probability of becoming successful in the future than the general category of comedians. A digital agency could use Bell Weather consumer data to find new talent.

There are able to also be very near term Bell Weather effects. Some of the media success predictors could have a very short lead time. For example, there are people who start the trend by sharing with their circle of friends. These might often be people with a lot of virtual friends (people Stanley Milgram who referred to people like this as connectors in the original Small World experiments). In cases where the popularity growth is very fast, an agent or studio might need to act quickly to be the first to establish a relationship with the creator. There may be business opportunities that are available early in the trajectory—perhaps booking a slot on a TV talk show or arranging for theatrical distribution while the buzz is still growing; perhaps doing sub-titles or foreign language translations to create a more global phenomenon. Algorithms are able to be tuned to be triggered based on who watches and in what time period including location information and demographic information about the watcher, time of day, or other information. The algorithms are able to then be used to generate automatic contacts to the appropriate people so that they are able to respond very quickly. For example, a music video could trigger someone who would want to manage or book the artist or sign them to a music distribution deal. Having access to the data will enable business to see opportunities early and respond effectively.

### Granular Skill Prediction:

The consumer Agora is filled with both implicit and explicit metadata. One form of explicit metadata is commentary. Parsing the commentary on a particular performance in an amateur video is able to inform opinions about the talent associated with that video. For example if a video has a lot of comments about the quality of the filming or the quality of the acting or the quality of the writing, those comments imply that that particular aspect of the production may be worth further investigation. Further, the value of those comments are able to be weighted of based on the historical value of the person doing the recommendation. So, for example, if a large percentage of lighting directors say that a video looks nice, an algorithm could imply that the lighting is well done. However, this does not have to be limited to lighting directors. Classes of lighting-sensitive-viewers are able to be created based on their historical likes, and this data is able to improve in accuracy over time. If a user starts with a virtual expert system based on the likes of professional lighting directors—weighting the opinions of those who worked on successful films above those who did not using a sliding scale so, for example academy award winning lighting directors would be higher in the rating than lighting directors who worked on popular titles and they would be higher in rating that those who worked professionally but never on a successful title. The user uses this subset “lighting intelligent consumers” to make decisions about which amateur videos are probably well lit. The user is able to also track the consumers whose opinions track with these experts. These people are called “lighting sensitive consumers.” The user is able to track all these lighting intelligent and lighting sensitive people over time and see how they do as individuals against the lighting awards within the industry and then adjust the weighting of these individuals based on their historical track record.

This same mechanism is able to be used to track all classes of talent; predicting the next talented actor or director or special effect supervisor—even from the masses of amateurs.

### The Video and Film Agora:

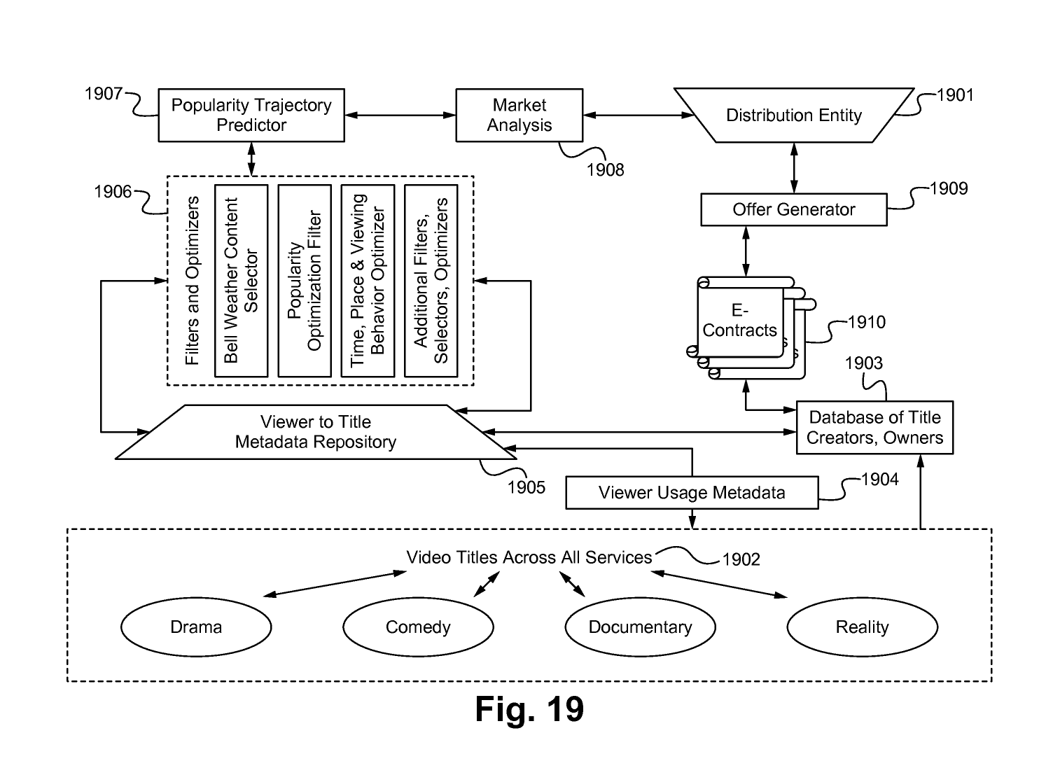

There is one further way to use the collective wisdom of the Agora, and that is to find finished videos that may be ready or near ready for distribution. This mostly relies on the viewing habits of the masses though it may be optimized by weighting from a Reputation Engine. The process involved is able to be seen in FIG. 19.

A Distribution Entity like a Studio, TV Network, Theatre Owner or other type of Distributor (1901) is looking for Videos and Films that it is able to distribute to Theaters, Television Channels and Online Aggregators. Metadata is collected from across all available online services (1902).

There are multiple sources of metadata. First is the metadata from the various Public Video Services (1902). This includes the metadata of Titles, and Creators and/or Owners and the Viewer Usage Metadata (1904) collected from the various services. There are multiple ways the Viewer Usage Metadata is able to be acquired. One way is using an API (Application Programming Interface) to log in to the data made available by the different Video Aggregators. There are two potential difficulties with getting this data. 1) is that there are liable to be privacy issues, and these need to be very carefully managed based on the privacy policies of the various Video Aggregators and it may be necessary to abstract away some of the User Metadata. User data may still be found by cross referencing against other User Metadata that the Distribution Entity has acquired from other sources. 2) The Distribution Entities will not want to share the richest set of data that they have, and, invariably, a business relationship (partial joint ownership, licensing) will be needed to have access to some of the data.

Since the Distribution Entity participates in the various repositories described above (Editors, Directors, Producers, Actors, Special Effects Supervisors), it will have access to a rich set of data about the creators of many of the titles across the services. This Database of Title Creators and Owners (1903) is associated with the Videos across All Services (1902) and, along with the Viewer Usage Metadata is stored in the Viewer to Title Metadata Repository (1905). Once there is a repository of Title Data, Creator Data and User Data collected from all of these sources (1905), it is important to Filter it and Optimize it (1906) so that it is able to be used effectively. Some of these filters include:

1) A Bell Weather Content Selector: This, as mentioned above, is a mechanism that collects viewers who have a history of being good judges of talent that will later become popular and uses their taste as a predictor of future success.

2) Popularity Optimization Filter: Titles cannot be judged just solely by how popular they are. The Distribution Entity is usually not interested in videos of pets or kids pulling pranks (except in cases like documentary aggregation). Beyond basic optimizations for content, there are optimizations for audience profile. Viewers who like police procedurals are a better judge of the value of a police procedural. Titles more popular with women may be more relevant in certain situations. Titles that are longer (e.g., over 20 minutes) indicate a relevance to TV viewing. Titles that are viewed multiple times are better. Titles that are often paused in a particular place may indicate special aspects of a scene that might need more clarity because it is confusing or might want to be repeated or varied because it is so popular. All aspects of granular parsing of popularity metrics and user profiles may be relevant.

3) Time, Place & Viewing Behavior Optimizer: Titles may be more relevant in different territories. Titles that are viewed in the evening may be more relevant for traditional TV viewing or may be better targeted at Evening TV viewers as opposed to Daytime TV Viewers.

4) Additional Filters, Selectors & Optimizers: There may be a plethora of other filters and optimizers. One example is seasonality of different slices of viewers or of different types of content. Another example is pace. Titles with faster cuts or different rhythms of cutting may appeal to certain viewers (e.g., faster cuts probably skew younger). Percentage of Close-ups compared to long shots is another metric. Also locale is a metric, e.g., on the water, in a big city, in the desert or more specifically in New York City or Phoenix Ariz. or Paris. Yet another is the make-up of the cast: is it mostly women, more attractive women, large women, fashionable women, burley men, teens, young children, animation of many different types.

Tying the consumer behavior to the details of the production will create data which is able to be used to make qualitative and quantitative decisions about distribution options. All of the above data is able to be stored and parsed by the Popularity Trajectory Predictor (1906). The Distribution Entity uses this Predictor to make educated guesses about what titles might be popular with which audiences.

A Market Analysis (1908) is done for each prospective title. This Analysis is used to determine the likely projected revenue for each title or group of titles. For example, if Title A was on trajectory X and previous titles with the same Trajectory have generated M dollars, that is able to provide a reasonable guess as to the value of the title being analyzed. Though each title will likely not follow the predicted trajectory, taken as a whole, the collection of a significant number of titles will, in the aggregate, follow that trajectory. The Popularity Trajectory Predictor (1907) will learn over time fine tuning its algorithms as it learns from an ever increasing set of experience data.

Once there is the set of titles, a Distribution Entity may want to license for further distribution, the list of Owners and Creators whose permission is needed in order to distribute and a proposed revenue projection, the Offer Generator is able to generate E-Contracts, and they are able to be sent to the various licensors, In some cases, the Offer may be best served using human interaction, and various negotiating entities are able to be notified to make the Offers.

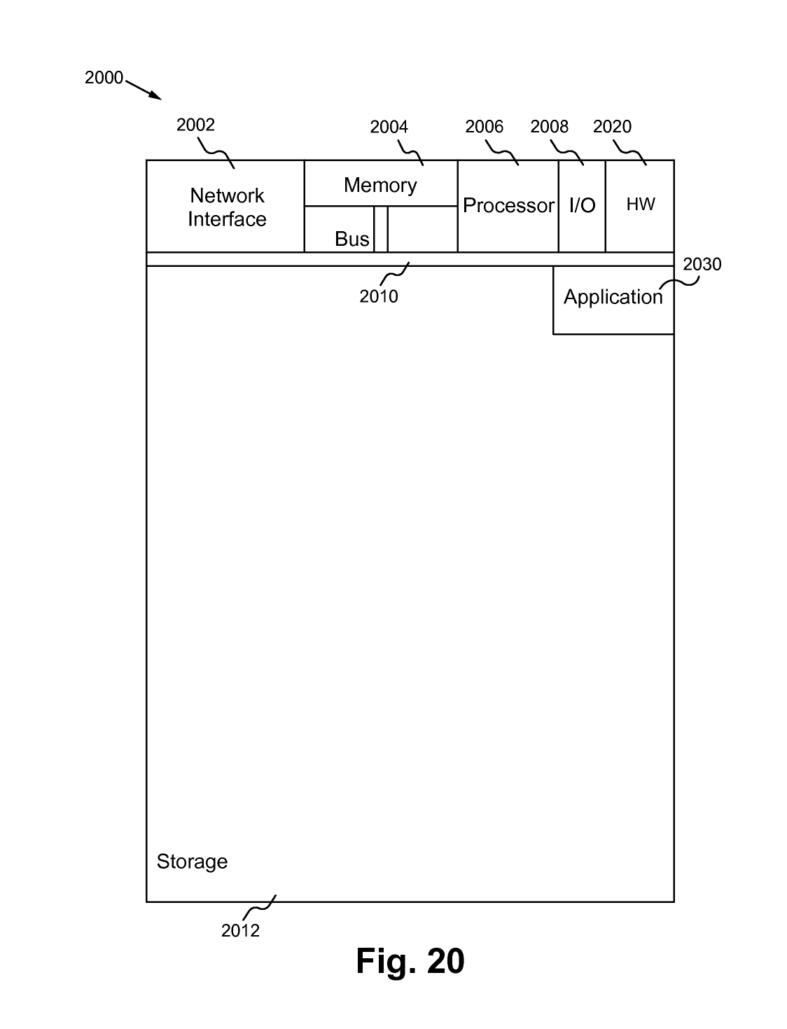

FIG. 20 illustrates a block diagram of an exemplary computing device configured to implement the video development method according to some embodiments. The computing device 2000 is able to be used to acquire, store, compute, process, communicate and/or display information such as images and videos. In general, a hardware structure suitable for implementing the computing device 2000 includes a network interface 2002, a memory 2004, a processor 2006, I/O device(s) 2008, a bus 2010 and a storage device 2012. The choice of processor is not critical as long as a suitable processor with sufficient speed is chosen. The memory 2004 is able to be any conventional computer memory known in the art. The storage device 2012 is able to include a hard drive, CDROM, CDRW, DVD, DVDRW, High Definition disc/drive, ultra-HD drive, flash memory card or any other storage device. The computing device 2000 is able to include one or more network interfaces 2002. An example of a network interface includes a network card connected to an Ethernet or other type of LAN. The I/O device(s) 2008 are able to include one or more of the following: keyboard, mouse, monitor, screen, printer, modem, touchscreen, button interface and other devices. Video development application(s) 2030 used to perform the video development method are likely to be stored in the storage device 2012 and memory 2004 and processed as applications are typically processed. More or fewer components shown in FIG. 20 are able to be included in the computing device 2000. In some embodiments, video development hardware 2020 is included. Although the computing device 2000 in FIG. 20 includes applications 2030 and hardware 2020 for the video development method, the video development method is able to be implemented on a computing device in hardware, firmware, software or any combination thereof. For example, in some embodiments, the video development applications 2030 are programmed in a memory and executed using a processor. In another example, in some embodiments, the video development hardware 2020 is programmed hardware logic including gates specifically designed to implement the video development method.

In some embodiments, the video development application(s) 2030 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, an augmented reality device, a virtual reality device, a home entertainment system, smart jewelry (e.g., smart watch) or any other suitable computing device.

To utilize the video development method, a device such as a computer or mobile phone is able to be used to communicate via the Virtual Agora. Any of the steps described herein are able to be implemented manually, automatically by a computer or a combination thereof.

In operation, the video development method enables users from across the world to collaborate to produce high quality work.

### Some Embodiments of a System and Methods for Creating, Modifying and Distributing Video Content Using Crowd Sourcing and Crowd Curation

1. A method programmed in a non-transitory memory of a device comprising:
   a. digitally registering an original script;
   b. defining and instantiating parameters of ownership and control related to the original script in an electronic contract;
   c. reviewing the original script among participants who are covered by the electronic contract;
   d. selecting and binding, by electronic contract, the participants who are to work on the original script;
   e. capturing a video or audio based on the original script using the participants;
   f. implementing digital effects on the video or audio using the participants;
   g. editing the video or audio using the participants; and
   h. selecting a marketing plan using the participants.
2. The method of clause 1 wherein the original script includes a standard script, a reality show idea or a documentary idea.
3. The method of clause 1 further comprising generating the original script including:
   i. binding of the original script to a creator using digital credentials;
   ii. generating the electronic contract representing terms of the binding; and
   iii. registration of the original script with an electronic repository comprising the original script, certification of ownership of the original script and the binding to the electronic contract which governs control of the original script.
4. The method of clause 1 wherein the electronic contract comprises:
   i. a data structure configured for containing rules of governance, control and ownership;
   ii. a binding electronic signature associated with each real person or legal entity guaranteeing their acceptance of the terms of the contract and agreeing to be bound by the contract;
   iii. an association of the electronic signature to an electronic signature authority which attests to the validity of the electronic signatures; and
   iv. governance rules and policies which determine policies for voting, policies for change of control, policies for change of ownership and venue of governing law.
5. The method of clause 1 further comprising generating and updating the electronic contract comprising:
   i. utilizing an electronic contract stub into which all entities, control, ownership and governance policies are placed;
   ii. associating the electronic contract with a parent entity that is uniquely identified;
   iii. associating the electronic contract with a first attested entity;
   iv. selection of parameters of governance;
   v. associating control and ownership parameters;
   vi. associating and binding of additional entities including levels of ownership and control of any payment;
   vii. electronic voting on the additional entities by existing entities; and
   viii. notifying the additional entities.
6. The method of clause 1 further comprising registering the original script comprising:
   i. registering the original script with an electronic storage repository which guarantees that no modifications have been made or are able to be made;
   ii. date and time stamping the original script so that the time of registrations is able to be determined; and
   iii. recording a digital signature of a registering entity and an attestation that the registering entity is the controlling entity for the original script.
7. The method of clause 1 wherein binding the participants includes:
   i. the electronic contract which is associated with registration at the time of the registration so all parameters of ownership and control of the original script at the time are able to be determined;
   ii. identification and location of the electronic contract; and
   iii. identification of all controlling entities as represented by the electronic contract.
8. The method of clause 1 further comprising determining a reputation of each of the participants, including:
   i. storing the reputation in one or more reputation information databases;
   ii. collating reputations before being placed in the one or more reputation information databases;
   iii. collecting data from multiple sources to determine the reputation, the multiple sources including:
      (1) anonymous contributions found on web logs or web sites and viability of the web logs and web sites and the individual contributions is weighted based on popularity and historical data;
      (2) box office grosses and box office location and size;
      (3) television rating services;
      (4) awards and reviews; or
      (5) identified persons or entities with a system or another peered system, wherein the weighting of the value of the recommendations of the identified persons or entities is increased or decreased based on relevancy parameters and on veracity parameters, wherein further weighting of the recommendations of the identified persons or entities is increased or decreased based on their association with other identified persons or entities who are more or less highly rated.
9. The method of clause 1 wherein generating the original script includes using a number of persons or entities, wherein:
   i. an initial writer is associated by the electronic contract to the entity which controls the original script;
   ii. additional writers are added as controlled by the electronic contract and as selected from a collection of registered writers, wherein such selection is informed by use of a reputation engine, wherein changes of control or ownership are proposed and voted upon using electronic contract governance.
10. The method of clause 1 wherein the original script is related to a documentary, wherein generating the documentary includes: using a number of persons or entities in generating the documentary, wherein a documentary producer is associated with a production entity, a director of photography is associated with that production entity, one or more editors may be associated with that production entity, individual camera operators agree to submit footage based on a form of agreed electronic contract, the footage is stored or referenced in a footage repository, the footage is rated based on opinions of the participants who have access to the footage referenced in the repository, opinions of the participants are weighted based on the reputations associated with the participants, and payments and credits are given to the camera operators as prescribed in the electronic contract.
11. The method of clause 10 further comprising generating and using the footage repository includes:
   i. associating footage with the camera operators using digital identifiers;
   ii. associating metadata with the footage based on a reputation information database, wherein the reputation information database is informed by the data of registered reviewers, wherein the reputation information database is informed by a reputation engine, wherein the reputation engine is informed by data from anonymous reviewers, wherein the reputation engine informs a clip metadata parser, wherein the clips informed are stack-ranked for applicability, and wherein the director of photography, the editor, the producer and the director use the clips and the associated metadata and ranking data for generating the original script.
12. The method of clause 1 wherein the original script is related to reality programming, including:
   i. registering a reality programming idea by a reality producer;
   ii. sending out a call for actors;
   iii. receiving signatures of electronic contracts and footage;
   iv. receiving votes by registered and non-registered users for actors;
   v. weighting the votes;
   vi. putting scenes together by an editor;
   vii. receiving votes by the registered and the non-registered users for the scenes;
   viii. weighting the votes;
   ix. compiling additional scenes and votes; and
   x. releasing a finished product.
13. The method of clause 1 further comprising searching for and adding talent, including:
   i. using a reputation engine to review a pool of professional talent;
   ii. using a different reputation engine to review a pool of amateur talent;
   iii. after potential talent is ranked from most viable to least viable, contacting the talent;
   iv. offering an electronic contracts to selected talent; and
   v. digitally signing electronic contracts, after negotiation.
14. The method of clause 1 further comprising connecting legal resources with entities or persons including:
   i. searching a pool of registered lawyers;
   ii. filtering the pool of lawyers based on reputation, pricing and applicability to the required work; and
   iii. negotiate electronic contracts which are signed by various entities using the lawyers representing the entities in the negotiation.
15. The method of clause 1 further comprising collecting data from amateurs including:
   i. aggregating links to footage from unregistered users along with other metadata associated with the footage;
   ii. aggregating and associating viewers associated with the footage;
   iii. aggregating and associating comments associated with the footage;
   iv. transforming the associated comments into performance quality metadata;
   v. factoring quality and reputation indices and collating the data in preparation for ranking; and
   vi. ranking videos against desired goals of the footage.
16. The method of clause 1 further comprising finding talent from among a large mass of public videos including:
   a. populating a metadata repository with persons from fields of a filming process endeavor;
   b. optimizing groups of fields of endeavor to separate each individual into the field or fields of endeavor most appropriate;
   c. based on a plurality of axes, the persons are additionally ranked based on recommendations associated with their capabilities;
   d. based on the data and rankings, making electronic offers; and
   e. memorializing accepted offers in electronic contracts.
17. The method of clause 1 further comprising finding a video with commercial potential from a mass of public videos including:
   a. generating a database of titles, creators and owners;
   b. merging a title, creator and owner database with viewer usage metadata;
   c. filtering and optimizing the metadata by following bell weather users, popularity optimization, time, place and viewing behavior optimization and other filters and optimizations;
   d. feeding a popularity trajectory predictor the optimizers and filters;
   e. matching popularity trajectory against market analysis; and
   f. feeding results from steps a-e into a distribution entity which determines distribution opportunities based on rankings and target audiences discovered.
18. A system comprising:
   a. a registration module configured for digitally registering an original script;
   b. a parameter module configured for defining and instantiating parameters of ownership and control related to the original script in an electronic contract;
   c. a review module configured for reviewing the original script among participants who are covered by the electronic contract;
   d. a selection module configured for selecting and binding, by electronic contract, the participants who are to work on the original script;
   e. a capture module configured for capturing a video or audio based on the original script using the participants;
   f. an effects module configured for implementing digital effects on the video or audio using the participants;
   g. an editing module configured for editing the video or audio using the participants; and
   h. a plan module configured for selecting a marketing plan using the participants.
19. The system of clause 18 wherein the original script includes a standard script, a reality show idea or a documentary idea.
20. The system of clause 18 further comprising a generation module configured for generating the original script including:
   i. binding of the original script to a creator using digital credentials;
   ii. generating the electronic contract representing terms of the binding; and
   iii. registration of the original script with an electronic repository comprising the original script, certification of ownership of the original script and the binding to the electronic contract which governs control of the original script.
21. The system of clause 18 wherein the electronic contract comprises:
   i. a data structure configured for containing rules of governance, control and ownership;
   ii. a binding electronic signature associated with each real person or legal entity guaranteeing their acceptance of the terms of the contract and agreeing to be bound by the contract;
   iii. an association of the electronic signature to an electronic signature authority which attests to the validity of the electronic signatures; and
   iv. governance rules and policies which determine policies for voting, policies for change of control, policies for change of ownership and venue of governing law.
22. The system of clause 18 further comprising an update module configured for generating and updating the electronic contract comprising:
   i. utilizing an electronic contract stub into which all entities, control, ownership and governance policies are placed;
   ii. associating the electronic contract with a parent entity that is uniquely identified;
   iii. associating the electronic contract with a first attested entity;
   iv. selection of parameters of governance;
   v. associating control and ownership parameters;
   vi. associating and binding of additional entities including levels of ownership and control of any payment;
   vii. electronic voting on the additional entities by existing entities; and
   viii. notifying the additional entities.
23. The system of clause 18 further comprising a script module configured for registering the original script comprising:
   i. registering the original script with an electronic storage repository which guarantees that no modifications have been made or are able to be made;
   ii. date and time stamping the original script so that the time of registrations is able to be determined; and
   iii. recording a digital signature of a registering entity and an attestation that the registering entity is the controlling entity for the original script.
24. The system of clause 18 wherein binding the participants includes:
   i. the electronic contract which is associated with registration at the time of the registration so all parameters of ownership and control of the original script at the time are able to be determined;
   ii. identification and location of the electronic contract; and
   iii. identification of all controlling entities as represented by the electronic contract.
25. The system of clause 18 further comprising a reputation module configured for determining a reputation of each of the participants, including:
   i. storing the reputation in one or more reputation information databases;
   ii. collating reputations before being placed in the one or more reputation information databases;
   iii. collecting data from multiple sources to determine the reputation, the multiple sources including:
      (1) anonymous contributions found on web logs or web sites and viability of the web logs and web sites and the individual contributions is weighted based on popularity and historical data;
      (2) box office grosses and box office location and size;
      (3) television rating services;
      (4) awards and reviews; or
      (5) identified persons or entities with a system or another peered system, wherein the weighting of the value of the recommendations of the identified persons or entities is increased or decreased based on relevancy parameters and on veracity parameters, wherein further weighting of the recommendations of the identified persons or entities is increased or decreased based on their association with other identified persons or entities who are more or less highly rated.
26. The system of clause 18 wherein generating the original script includes using a number of persons or entities, wherein:
   i. an initial writer is associated by the electronic contract to the entity which controls the original script;
   ii. additional writers are added as controlled by the electronic contract and as selected from a collection of registered writers, wherein such selection is informed by use of a reputation engine, wherein changes of control or ownership are proposed and voted upon using electronic contract governance.
27. The system of clause 18 wherein the original script is related to a documentary, wherein generating the documentary includes: using a number of persons or entities in generating the documentary, wherein a documentary producer is associated with a production entity, a director of photography is associated with that production entity, one or more editors may be associated with that production entity, individual camera operators agree to submit footage based on a form of agreed electronic contract, the footage is stored or referenced in a footage repository, the footage is rated based on opinions of the participants who have access to the footage referenced in the repository, opinions of the participants are weighted based on the reputations associated with the participants, and payments and credits are given to the camera operators as prescribed in the electronic contract.
28. The system of clause 27 further comprising a repository module configured for generating and using the footage repository includes:
   i. associating footage with the camera operators using digital identifiers;
   ii. associating metadata with the footage based on a reputation information database, wherein the reputation information database is informed by the data of registered reviewers, wherein the reputation information database is informed by a reputation engine, wherein the reputation engine is informed by data from anonymous reviewers, wherein the reputation engine informs a clip metadata parser, wherein the clips informed are stack-ranked for applicability, and wherein the director of photography, the editor, the producer and the director use the clips and the associated metadata and ranking data for generating the original script.
29. The system of clause 18 wherein the original script is related to reality programming, including:
   i. registering a reality programming idea by a reality producer;
   ii. sending out a call for actors;
   iii. receiving signatures of electronic contracts and footage;
   iv. receiving votes by registered and non-registered users for actors;
   v. weighting the votes;
   vi. putting scenes together by an editor;
   vii. receiving votes by the registered and the non-registered users for the scenes;
   viii. weighting the votes;
   ix. compiling additional scenes and votes; and
   x. releasing a finished product.
30. The system of clause 18 further comprising a talent module configured for searching for and adding talent, including:
   i. using a reputation engine to review a pool of professional talent;
   ii. using a different reputation engine to review a pool of amateur talent;
   iii. after potential talent is ranked from most viable to least viable, contacting the talent;
   iv. offering an electronic contracts to selected talent; and
   v. digitally signing electronic contracts, after negotiation.
31. The system of clause 18 further comprising a legal module configured for connecting legal resources with entities or persons including:
   i. searching a pool of registered lawyers;
   ii. filtering the pool of lawyers based on reputation, pricing and applicability to the required work; and
   iii. negotiate electronic contracts which are signed by various entities using the lawyers representing the entities in the negotiation.
32. The system of clause 18 further comprising an amateur module configured for collecting data from amateurs including:
   i. aggregating links to footage from unregistered users along with other metadata associated with the footage;
   ii. aggregating and associating viewers associated with the footage;
   iii. aggregating and associating comments associated with the footage;
   iv. transforming the associated comments into performance quality metadata;
   v. factoring quality and reputation indices and collating the data in preparation for ranking; and
   vi. ranking videos against desired goals of the footage.
33. The system of clause 18 further comprising a mass module configured for finding talent from among a large mass of public videos including:
   a. populating a metadata repository with persons from fields of a filming process endeavor;
   b. optimizing groups of fields of endeavor to separate each individual into the field or fields of endeavor most appropriate;
   c. based on a plurality of axes, the persons are additionally ranked based on recommendations associated with their capabilities;
   d. based on the data and rankings, making electronic offers; and
   e. memorializing accepted offers in electronic contracts.
34. The system of clause 18 further comprising a commercial module configured for finding a video with commercial potential from a mass of public videos including:
   a. generating a database of titles, creators and owners;
   b. merging a title, creator and owner database with viewer usage metadata;
   c. filtering and optimizing the metadata by following bell weather users, popularity optimization, time, place and viewing behavior optimization and other filters and optimizations;
   d. feeding a popularity trajectory predictor the optimizers and filters;
   e. matching popularity trajectory against market analysis; and
   f. feeding results from steps a-e into a distribution entity which determines distribution opportunities based on rankings and target audiences discovered.
35. An apparatus comprising:
   a. a non-transitory memory for storing an application, the application for:
      i. digitally registering an original script;
      ii. defining and instantiating parameters of ownership and control related to the original script in an electronic contract;
      iii. reviewing the original script among participants who are covered by the electronic contract;
      iv. selecting and binding, by electronic contract, the participants who are to work on the original script;
      v. capturing a video or audio based on the original script using the participants;
      vi. implementing digital effects on the video or audio using the participants;
      vii. editing the video or audio using the participants; and
      viii. selecting a marketing plan using the participants; and
   b. a processing component coupled to the memory, the processing component configured for processing the application.
36. The apparatus of clause 35 wherein the original script includes a standard script, a reality show idea or a documentary idea.
37. The apparatus of clause 35 wherein the application is further for generating the original script including:
   i. binding of the original script to a creator using digital credentials;
   ii. generating the electronic contract representing terms of the binding; and
   iii. registration of the original script with an electronic repository comprising the original script, certification of ownership of the original script and the binding to the electronic contract which governs control of the original script.
38. The apparatus of clause 35 wherein the electronic contract comprises:
   i. a data structure configured for containing rules of governance, control and ownership;
   ii. a binding electronic signature associated with each real person or legal entity guaranteeing their acceptance of the terms of the contract and agreeing to be bound by the contract;
   iii. an association of the electronic signature to an electronic signature authority which attests to the validity of the electronic signatures; and
   iv. governance rules and policies which determine policies for voting, policies for change of control, policies for change of ownership and venue of governing law.
39. The apparatus of clause 35 wherein the application is further for generating and updating the electronic contract comprising:
   i. utilizing an electronic contract stub into which all entities, control, ownership and governance policies are placed;
   ii. associating the electronic contract with a parent entity that is uniquely identified;
   iii. associating the electronic contract with a first attested entity;
   iv. selection of parameters of governance;
   v. associating control and ownership parameters;
   vi. associating and binding of additional entities including levels of ownership and control of any payment;
   vii. electronic voting on the additional entities by existing entities; and
   viii. notifying the additional entities.
40. The apparatus of clause 35 wherein the application is further for registering the original script comprising:
   i. registering the original script with an electronic storage repository which guarantees that no modifications have been made or are able to be made;
   ii. date and time stamping the original script so that the time of registrations is able to be determined; and
   iii. recording a digital signature of a registering entity and an attestation that the registering entity is the controlling entity for the original script.
41. The apparatus of clause 35 wherein binding the participants includes:
   i. the electronic contract which is associated with registration at the time of the registration so all parameters of ownership and control of the original script at the time are able to be determined;
   ii. identification and location of the electronic contract; and
   iii. identification of all controlling entities as represented by the electronic contract.
42. The apparatus of clause 35 wherein the application is further for determining a reputation of each of the participants, including:
   i. storing the reputation in one or more reputation information databases;
   ii. collating reputations before being placed in the one or more reputation information databases;
   iii. collecting data from multiple sources to determine the reputation, the multiple sources including:
      (1) anonymous contributions found on web logs or web sites and viability of the web logs and web sites and the individual contributions is weighted based on popularity and historical data;
      (2) box office grosses and box office location and size;
      (3) television rating services;
      (4) awards and reviews; or
      (5) identified persons or entities with a system or another peered system, wherein the weighting of the value of the recommendations of the identified persons or entities is increased or decreased based on relevancy parameters and on veracity parameters, wherein further weighting of the recommendations of the identified persons or entities is increased or decreased based on their association with other identified persons or entities who are more or less highly rated.
43. The apparatus of clause 35 wherein generating the original script includes using a number of persons or entities, wherein:
   i. an initial writer is associated by the electronic contract to the entity which controls the original script;
   ii. additional writers are added as controlled by the electronic contract and as selected from a collection of registered writers, wherein such selection is informed by use of a reputation engine, wherein changes of control or ownership are proposed and voted upon using electronic contract governance.
44. The apparatus of clause 35 wherein the original script is related to a documentary, wherein generating the documentary includes: using a number of persons or entities in generating the documentary, wherein a documentary producer is associated with a production entity, a director of photography is associated with that production entity, one or more editors may be associated with that production entity, individual camera operators agree to submit footage based on a form of agreed electronic contract, the footage is stored or referenced in a footage repository, the footage is rated based on opinions of the participants who have access to the footage referenced in the repository, opinions of the participants are weighted based on the reputations associated with the participants, and payments and credits are given to the camera operators as prescribed in the electronic contract.
45. The apparatus of clause 44 wherein the application is further for generating and using the footage repository includes:
   i. associating footage with the camera operators using digital identifiers;
   ii. associating metadata with the footage based on a reputation information database, wherein the reputation information database is informed by the data of registered reviewers, wherein the reputation information database is informed by a reputation engine, wherein the reputation engine is informed by data from anonymous reviewers, wherein the reputation engine informs a clip metadata parser, wherein the clips informed are stack-ranked for applicability, and wherein the director of photography, the editor, the producer and the director use the clips and the associated metadata and ranking data for generating the original script.
46. The apparatus of clause 35 wherein the original script is related to reality programming, including:
   i. registering a reality programming idea by a reality producer;
   ii. sending out a call for actors;
   iii. receiving signatures of electronic contracts and footage;
   iv. receiving votes by registered and non-registered users for actors;
   v. weighting the votes;
   vi. putting scenes together by an editor;
   vii. receiving votes by the registered and the non-registered users for the scenes;
   viii. weighting the votes;
   ix. compiling additional scenes and votes; and
   x. releasing a finished product.
47. The apparatus of clause 35 wherein the application is further for searching for and adding talent, including:
   i. using a reputation engine to review a pool of professional talent;
   ii. using a different reputation engine to review a pool of amateur talent;
   iii. after potential talent is ranked from most viable to least viable, contacting the talent;
   iv. offering an electronic contracts to selected talent; and
   v. digitally signing electronic contracts, after negotiation.
48. The apparatus of clause 35 wherein the application is further for connecting legal resources with entities or persons including:
   i. searching a pool of registered lawyers;
   ii. filtering the pool of lawyers based on reputation, pricing and applicability to the required work; and
   iii. negotiate electronic contracts which are signed by various entities using the lawyers representing the entities in the negotiation.
49. The apparatus of clause 35 wherein the application is further for collecting data from amateurs including:
   i. aggregating links to footage from unregistered users along with other metadata associated with the footage;
   ii. aggregating and associating viewers associated with the footage;
   iii. aggregating and associating comments associated with the footage;
   iv. transforming the associated comments into performance quality metadata;
   v. factoring quality and reputation indices and collating the data in preparation for ranking; and
   vi. ranking videos against desired goals of the footage.
50. The apparatus of clause 35 wherein the application is further for finding talent from among a large mass of public videos including:
   a. populating a metadata repository with persons from fields of a filming process endeavor;
   b. optimizing groups of fields of endeavor to separate each individual into the field or fields of endeavor most appropriate;
   c. based on a plurality of axes, the persons are additionally ranked based on recommendations associated with their capabilities;
   d. based on the data and rankings, making electronic offers; and
   e. memorializing accepted offers in electronic contracts.
51. The apparatus of clause 35 wherein the application is further for finding a video with commercial potential from a mass of public videos including:
   a. generating a database of titles, creators and owners;
   b. merging a title, creator and owner database with viewer usage metadata;
   c. filtering and optimizing the metadata by following bell weather users, popularity optimization, time, place and viewing behavior optimization and other filters and optimizations;
   d. feeding a popularity trajectory predictor the optimizers and filters;
   e. matching popularity trajectory against market analysis; and
   f. feeding results from steps a-e into a distribution entity which determines distribution opportunities based on rankings and target audiences discovered.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
a. digitally registering an original script;
b. defining and instantiating parameters of ownership and control related to the original script in an electronic contract;
c. reviewing the original script among participants who are covered by the electronic contract;
d. selecting and binding, by electronic contract, the participants who are to work on the original script;
e. capturing a video or audio based on the original script using the participants;
f. implementing digital effects on the video or audio using the participants;
g. editing the video or audio using the participants; and
h. selecting a marketing plan using the participants.

2. The method of claim 1 wherein the original script includes a standard script, a reality show idea or a documentary idea.

3. The method of claim 1 further comprising generating the original script including:
i. binding of the original script to a creator using digital credentials;
ii. generating the electronic contract representing terms of the binding; and
iii. registration of the original script with an electronic repository comprising the original script, certification of ownership of the original script and the binding to the electronic contract which governs control of the original script.

4. The method of claim 1 wherein the electronic contract comprises:
i. a data structure configured for containing rules of governance, control and ownership;
ii. a binding electronic signature associated with each real person or legal entity guaranteeing their acceptance of the terms of the contract and agreeing to be bound by the contract;
iii. an association of the electronic signature to an electronic signature authority which attests to the validity of the electronic signatures; and
iv. governance rules and policies which determine policies for voting, policies for change of control, policies for change of ownership and venue of governing law.

5. The method of claim 1 further comprising generating and updating the electronic contract comprising:
i. utilizing an electronic contract stub into which all entities, control, ownership and governance policies are placed;
ii. associating the electronic contract with a parent entity that is uniquely identified;
iii. associating the electronic contract with a first attested entity;
iv. selection of parameters of governance;
v. associating control and ownership parameters;
vi. associating and binding of additional entities including levels of ownership and control of any payment;
vii. electronic voting on the additional entities by existing entities; and
viii. notifying the additional entities.

6. The method of claim 1 further comprising registering the original script comprising:
i. registering the original script with an electronic storage repository which guarantees that no modifications have been made or are able to be made;
ii. date and time stamping the original script so that the time of registrations is able to be determined; and
iii. recording a digital signature of a registering entity and an attestation that the registering entity is the controlling entity for the original script.

7. The method of claim 1 wherein binding the participants includes:
i. the electronic contract which is associated with registration at the time of the registration so all parameters of ownership and control of the original script at the time are able to be determined;
ii. identification and location of the electronic contract; and
iii. identification of all controlling entities as represented by the electronic contract.

8. The method of claim 1 further comprising determining a reputation of each of the participants, including:
i. storing the reputation in one or more reputation information databases;
ii. collating reputations before being placed in the one or more reputation information databases;
iii. collecting data from multiple sources to determine the reputation, the multiple sources including:
(1) anonymous contributions found on web logs or web sites and viability of the web logs and web sites and the individual contributions is weighted based on popularity and historical data;
(2) box office grosses and box office location and size;
(3) television rating services;
(4) awards and reviews; or
(5) identified persons or entities with a system or another peered system, wherein the weighting of the value of the recommendations of the identified persons or entities is increased or decreased based on relevancy parameters and on veracity parameters, wherein further weighting of the recommendations of the identified persons or entities is increased or decreased based on their association with other identified persons or entities who are more or less highly rated.

9. The method of claim 1 wherein generating the original script includes using a number of persons or entities, wherein:
i. an initial writer is associated by the electronic contract to the entity which controls the original script;
ii. additional writers are added as controlled by the electronic contract and as selected from a collection of registered writers, wherein such selection is informed by use of a reputation engine, wherein changes of control or ownership are proposed and voted upon using electronic contract governance.

10. The method of claim 1 wherein the original script is related to a documentary, wherein generating the documentary includes: using a number of persons or entities in generating the documentary, wherein a documentary producer is associated with a production entity, a director of photography is associated with that production entity, one or more editors may be associated with that production entity, individual camera operators agree to submit footage based on a form of agreed electronic contract, the footage is stored or referenced in a footage repository, the footage is rated based on opinions of the participants who have access to the footage referenced in the repository, opinions of the participants are weighted based on the reputations associated with the participants, and payments and credits are given to the camera operators as prescribed in the electronic contract.

11. The method of claim 10 further comprising generating and using the footage repository includes:
i. associating footage with the camera operators using digital identifiers;
ii. associating metadata with the footage based on a reputation information database, wherein the reputation information database is informed by the data of registered reviewers, wherein the reputation information database is informed by a reputation engine, wherein the reputation engine is informed by data from anonymous reviewers, wherein the reputation engine informs a clip metadata parser, wherein the clips informed are stack-ranked for applicability, and wherein the director of photography, the editor, the producer and the director use the clips and the associated metadata and ranking data for generating the original script.

12. The method of claim 1 wherein the original script is related to reality programming, including:
i. registering a reality programming idea by a reality producer;
ii. sending out a call for actors;
iii. receiving signatures of electronic contracts and footage;
iv. receiving votes by registered and non-registered users for actors;
v. weighting the votes;
vi. putting scenes together by an editor;
vii. receiving votes by the registered and the non-registered users for the scenes;
viii. weighting the votes;
ix. compiling additional scenes and votes; and
x. releasing a finished product.

13. The method of claim 1 further comprising searching for and adding talent, including:
i. using a reputation engine to review a pool of professional talent;
ii. using a different reputation engine to review a pool of amateur talent;
iii. after potential talent is ranked from most viable to least viable, contacting the talent;
iv. offering an electronic contracts to selected talent; and
v. digitally signing electronic contracts, after negotiation.

14. The method of claim 1 further comprising connecting legal resources with entities or persons including:
i. searching a pool of registered lawyers;
ii. filtering the pool of lawyers based on reputation, pricing and applicability to the required work; and
iii. negotiate electronic contracts which are signed by various entities using the lawyers representing the entities in the negotiation.

15. The method of claim 1 further comprising collecting data from amateurs including:
i. aggregating links to footage from unregistered users along with other metadata associated with the footage;
ii. aggregating and associating viewers associated with the footage;
iii. aggregating and associating comments associated with the footage;
iv. transforming the associated comments into performance quality metadata;
v. factoring quality and reputation indices and collating the data in preparation for ranking; and
vi. ranking videos against desired goals of the footage.

16. The method of claim 1 further comprising finding talent from among a large mass of public videos including:
a. populating a metadata repository with persons from fields of a filming process endeavor;
b. optimizing groups of fields of endeavor to separate each individual into the field or fields of endeavor most appropriate;
c. based on a plurality of axes, the persons are additionally ranked based on recommendations associated with their capabilities;
d. based on the data and rankings, making electronic offers; and
e. memorializing accepted offers in electronic contracts.

17. The method of claim 1 further comprising finding a video with commercial potential from a mass of public videos including:
a. generating a database of titles, creators and owners;
b. merging a title, creator and owner database with viewer usage metadata;
c. filtering and optimizing the metadata by following bell weather users, popularity optimization, time, place and viewing behavior optimization and other filters and optimizations;
d. feeding a popularity trajectory predictor the optimizers and filters;
e. matching popularity trajectory against market analysis; and
f. feeding results from steps a-e into a distribution entity which determines distribution opportunities based on rankings and target audiences discovered.

18. A system comprising:
a. a registration module configured for digitally registering an original script;
b. a parameter module configured for defining and instantiating parameters of ownership and control related to the original script in an electronic contract;
c. a review module configured for reviewing the original script among participants who are covered by the electronic contract;
d. a selection module configured for selecting and binding, by electronic contract, the participants who are to work on the original script;
e. a capture module configured for capturing a video or audio based on the original script using the participants;
f. an effects module configured for implementing digital effects on the video or audio using the participants;
g. an editing module configured for editing the video or audio using the participants; and
h. a plan module configured for selecting a marketing plan using the participants.

19. The system of claim 18 wherein the original script includes a standard script, a reality show idea or a documentary idea.

20. The system of claim 18 further comprising a generation module configured for generating the original script including:
i. binding of the original script to a creator using digital credentials;
ii. generating the electronic contract representing terms of the binding; and
iii. registration of the original script with an electronic repository comprising the original script, certification of ownership of the original script and the binding to the electronic contract which governs control of the original script.

21. The system of claim 18 wherein the electronic contract comprises:
i. a data structure configured for containing rules of governance, control and ownership;
ii. a binding electronic signature associated with each real person or legal entity guaranteeing their acceptance of the terms of the contract and agreeing to be bound by the contract;
iii. an association of the electronic signature to an electronic signature authority which attests to the validity of the electronic signatures; and
iv. governance rules and policies which determine policies for voting, policies for change of control, policies for change of ownership and venue of governing law.

22. The system of claim 18 further comprising an update module configured for generating and updating the electronic contract comprising:
i. utilizing an electronic contract stub into which all entities, control, ownership and governance policies are placed;
ii. associating the electronic contract with a parent entity that is uniquely identified;
iii. associating the electronic contract with a first attested entity;
iv. selection of parameters of governance;
v. associating control and ownership parameters;
vi. associating and binding of additional entities including levels of ownership and control of any payment;
vii. electronic voting on the additional entities by existing entities; and
viii. notifying the additional entities.

23. The system of claim 18 further comprising a script module configured for registering the original script comprising:
i. registering the original script with an electronic storage repository which guarantees that no modifications have been made or are able to be made;
ii. date and time stamping the original script so that the time of registrations is able to be determined; and
iii. recording a digital signature of a registering entity and an attestation that the registering entity is the controlling entity for the original script.

24. The system of claim 18 wherein binding the participants includes:
i. the electronic contract which is associated with registration at the time of the registration so all parameters of ownership and control of the original script at the time are able to be determined;
ii. identification and location of the electronic contract; and
iii. identification of all controlling entities as represented by the electronic contract.

25. The system of claim 18 further comprising a reputation module configured for determining a reputation of each of the participants, including:
i. storing the reputation in one or more reputation information databases;
ii. collating reputations before being placed in the one or more reputation information databases;
iii. collecting data from multiple sources to determine the reputation, the multiple sources including:
(1) anonymous contributions found on web logs or web sites and viability of the web logs and web sites and the individual contributions is weighted based on popularity and historical data;
(2) box office grosses and box office location and size;
(3) television rating services;
(4) awards and reviews; or
(5) identified persons or entities with a system or another peered system, wherein the weighting of the value of the recommendations of the identified persons or entities is increased or decreased based on relevancy parameters and on veracity parameters, wherein further weighting of the recommendations of the identified persons or entities is increased or decreased based on their association with other identified persons or entities who are more or less highly rated.

26. The system of claim 18 wherein generating the original script includes using a number of persons or entities, wherein:
i. an initial writer is associated by the electronic contract to the entity which controls the original script;
ii. additional writers are added as controlled by the electronic contract and as selected from a collection of registered writers, wherein such selection is informed by use of a reputation engine, wherein changes of control or ownership are proposed and voted upon using electronic contract governance.

27. The system of claim 18 wherein the original script is related to a documentary, wherein generating the documentary includes: using a number of persons or entities in generating the documentary, wherein a documentary producer is associated with a production entity, a director of photography is associated with that production entity, one or more editors may be associated with that production entity, individual camera operators agree to submit footage based on a form of agreed electronic contract, the footage is stored or referenced in a footage repository, the footage is rated based on opinions of the participants who have access to the footage referenced in the repository, opinions of the participants are weighted based on the reputations associated with the participants, and payments and credits are given to the camera operators as prescribed in the electronic contract.

28. The system of claim 27 further comprising a repository module configured for generating and using the footage repository includes:
i. associating footage with the camera operators using digital identifiers;
ii. associating metadata with the footage based on a reputation information database, wherein the reputation information database is informed by the data of registered reviewers, wherein the reputation information database is informed by a reputation engine, wherein the reputation engine is informed by data from anonymous reviewers, wherein the reputation engine informs a clip metadata parser, wherein the clips informed are stack-ranked for applicability, and wherein the director of photography, the editor, the producer and the director use the clips and the associated metadata and ranking data for generating the original script.

29. The system of claim 18 wherein the original script is related to reality programming, including:
i. registering a reality programming idea by a reality producer;
ii. sending out a call for actors;
iii. receiving signatures of electronic contracts and footage;
iv. receiving votes by registered and non-registered users for actors;
v. weighting the votes;
vi. putting scenes together by an editor;
vii. receiving votes by the registered and the non-registered users for the scenes;
viii. weighting the votes;
ix. compiling additional scenes and votes; and
x. releasing a finished product.

30. The system of claim 18 further comprising a talent module configured for searching for and adding talent, including:
i. using a reputation engine to review a pool of professional talent;
ii. using a different reputation engine to review a pool of amateur talent;
iii. after potential talent is ranked from most viable to least viable, contacting the talent;
iv. offering an electronic contracts to selected talent; and
v. digitally signing electronic contracts, after negotiation.

31. The system of claim 18 further comprising a legal module configured for connecting legal resources with entities or persons including:
i. searching a pool of registered lawyers;
ii. filtering the pool of lawyers based on reputation, pricing and applicability to the required work; and
iii. negotiate electronic contracts which are signed by various entities using the lawyers representing the entities in the negotiation.

32. The system of claim 18 further comprising an amateur module configured for collecting data from amateurs including:
i. aggregating links to footage from unregistered users along with other metadata associated with the footage;
ii. aggregating and associating viewers associated with the footage;
iii. aggregating and associating comments associated with the footage;
iv. transforming the associated comments into performance quality metadata;
v. factoring quality and reputation indices and collating the data in preparation for ranking; and
vi. ranking videos against desired goals of the footage.

33. The system of claim 18 further comprising a mass module configured for finding talent from among a large mass of public videos including:
a. populating a metadata repository with persons from fields of a filming process endeavor;
b. optimizing groups of fields of endeavor to separate each individual into the field or fields of endeavor most appropriate;
c. based on a plurality of axes, the persons are additionally ranked based on recommendations associated with their capabilities;
d. based on the data and rankings, making electronic offers; and
e. memorializing accepted offers in electronic contracts.

34. The system of claim 18 further comprising a commercial module configured for finding a video with commercial potential from a mass of public videos including:
a. generating a database of titles, creators and owners;
b. merging a title, creator and owner database with viewer usage metadata;
c. filtering and optimizing the metadata by following bell weather users, popularity optimization, time, place and viewing behavior optimization and other filters and optimizations;
d. feeding a popularity trajectory predictor the optimizers and filters;
e. matching popularity trajectory against market analysis; and
f. feeding results from steps a-e into a distribution entity which determines distribution opportunities based on rankings and target audiences discovered.

35. An apparatus comprising:
a. a non-transitory memory for storing an application, the application for:
i. digitally registering an original script;
ii. defining and instantiating parameters of ownership and control related to the original script in an electronic contract;
iii. reviewing the original script among participants who are covered by the electronic contract;
iv. selecting and binding, by electronic contract, the participants who are to work on the original script;
v. capturing a video or audio based on the original script using the participants;
vi. implementing digital effects on the video or audio using the participants;
vii. editing the video or audio using the participants; and
viii. selecting a marketing plan using the participants; and
b. a processing component coupled to the memory, the processing component configured for processing the application.

36. The apparatus of claim 35 wherein the original script includes a standard script, a reality show idea or a documentary idea.

37. The apparatus of claim 35 wherein the application is further for generating the original script including:
i. binding of the original script to a creator using digital credentials;
ii. generating the electronic contract representing terms of the binding; and
iii. registration of the original script with an electronic repository comprising the original script, certification of ownership of the original script and the binding to the electronic contract which governs control of the original script.

38. The apparatus of claim 35 wherein the electronic contract comprises:
i. a data structure configured for containing rules of governance, control and ownership;
ii. a binding electronic signature associated with each real person or legal entity guaranteeing their acceptance of the terms of the contract and agreeing to be bound by the contract;
iii. an association of the electronic signature to an electronic signature authority which attests to the validity of the electronic signatures; and
iv. governance rules and policies which determine policies for voting, policies for change of control, policies for change of ownership and venue of governing law.

39. The apparatus of claim 35 wherein the application is further for generating and updating the electronic contract comprising:
i. utilizing an electronic contract stub into which all entities, control, ownership and governance policies are placed;
ii. associating the electronic contract with a parent entity that is uniquely identified;
iii. associating the electronic contract with a first attested entity;
iv. selection of parameters of governance;
v. associating control and ownership parameters;
vi. associating and binding of additional entities including levels of ownership and control of any payment;
vii. electronic voting on the additional entities by existing entities; and
viii. notifying the additional entities.

40. The apparatus of claim 35 wherein the application is further for registering the original script comprising:
i. registering the original script with an electronic storage repository which guarantees that no modifications have been made or are able to be made;
ii. date and time stamping the original script so that the time of registrations is able to be determined; and
iii. recording a digital signature of a registering entity and an attestation that the registering entity is the controlling entity for the original script.

41. The apparatus of claim 35 wherein binding the participants includes:
i. the electronic contract which is associated with registration at the time of the registration so all parameters of ownership and control of the original script at the time are able to be determined;
ii. identification and location of the electronic contract; and
iii. identification of all controlling entities as represented by the electronic contract.

42. The apparatus of claim 35 wherein the application is further for determining a reputation of each of the participants, including:
i. storing the reputation in one or more reputation information databases;
ii. collating reputations before being placed in the one or more reputation information databases;
iii. collecting data from multiple sources to determine the reputation, the multiple sources including:
(1) anonymous contributions found on web logs or web sites and viability of the web logs and web sites and the individual contributions is weighted based on popularity and historical data;
(2) box office grosses and box office location and size;
(3) television rating services;
(4) awards and reviews; or
(5) identified persons or entities with a system or another peered system, wherein the weighting of the value of the recommendations of the identified persons or entities is increased or decreased based on relevancy parameters and on veracity parameters, wherein further weighting of the recommendations of the identified persons or entities is increased or decreased based on their association with other identified persons or entities who are more or less highly rated.

43. The apparatus of claim 35 wherein generating the original script includes using a number of persons or entities, wherein:
i. an initial writer is associated by the electronic contract to the entity which controls the original script;
ii. additional writers are added as controlled by the electronic contract and as selected from a collection of registered writers, wherein such selection is informed by use of a reputation engine, wherein changes of control or ownership are proposed and voted upon using electronic contract governance.

44. The apparatus of claim 35 wherein the original script is related to a documentary, wherein generating the documentary includes: using a number of persons or entities in generating the documentary, wherein a documentary producer is associated with a production entity, a director of photography is associated with that production entity, one or more editors may be associated with that production entity, individual camera operators agree to submit footage based on a form of agreed electronic contract, the footage is stored or referenced in a footage repository, the footage is rated based on opinions of the participants who have access to the footage referenced in the repository, opinions of the participants are weighted based on the reputations associated with the participants, and payments and credits are given to the camera operators as prescribed in the electronic contract.

45. The apparatus of claim 44 wherein the application is further for generating and using the footage repository includes:
i. associating footage with the camera operators using digital identifiers;
ii. associating metadata with the footage based on a reputation information database, wherein the reputation information database is informed by the data of registered reviewers, wherein the reputation information database is informed by a reputation engine, wherein the reputation engine is informed by data from anonymous reviewers, wherein the reputation engine informs a clip metadata parser, wherein the clips informed are stack-ranked for applicability, and wherein the director of photography, the editor, the producer and the director use the clips and the associated metadata and ranking data for generating the original script.

46. The apparatus of claim 35 wherein the original script is related to reality programming, including:
i. registering a reality programming idea by a reality producer;
ii. sending out a call for actors;
iii. receiving signatures of electronic contracts and footage;
iv. receiving votes by registered and non-registered users for actors;
v. weighting the votes;
vi. putting scenes together by an editor;
vii. receiving votes by the registered and the non-registered users for the scenes;
viii. weighting the votes;
ix. compiling additional scenes and votes; and
x. releasing a finished product.

47. The apparatus of claim 35 wherein the application is further for searching for and adding talent, including:
i. using a reputation engine to review a pool of professional talent;
ii. using a different reputation engine to review a pool of amateur talent;
iii. after potential talent is ranked from most viable to least viable, contacting the talent;
iv. offering an electronic contracts to selected talent; and
v. digitally signing electronic contracts, after negotiation.

48. The apparatus of claim 35 wherein the application is further for connecting legal resources with entities or persons including:
i. searching a pool of registered lawyers;
ii. filtering the pool of lawyers based on reputation, pricing and applicability to the required work; and
iii. negotiate electronic contracts which are signed by various entities using the lawyers representing the entities in the negotiation.

49. The apparatus of claim 35 wherein the application is further for collecting data from amateurs including:
i. aggregating links to footage from unregistered users along with other metadata associated with the footage;
ii. aggregating and associating viewers associated with the footage;
iii. aggregating and associating comments associated with the footage;
iv. transforming the associated comments into performance quality metadata;
v. factoring quality and reputation indices and collating the data in preparation for ranking; and
vi. ranking videos against desired goals of the footage.

50. The apparatus of claim 35 wherein the application is further for finding talent from among a large mass of public videos including:
a. populating a metadata repository with persons from fields of a filming process endeavor;
b. optimizing groups of fields of endeavor to separate each individual into the field or fields of endeavor most appropriate;
c. based on a plurality of axes, the persons are additionally ranked based on recommendations associated with their capabilities;
d. based on the data and rankings, making electronic offers; and
e. memorializing accepted offers in electronic contracts.

51. The apparatus of claim 35 wherein the application is further for finding a video with commercial potential from a mass of public videos including:
a. generating a database of titles, creators and owners;
b. merging a title, creator and owner database with viewer usage metadata;
c. filtering and optimizing the metadata by following bell weather users, popularity optimization, time, place and viewing behavior optimization and other filters and optimizations;
d. feeding a popularity trajectory predictor the optimizers and filters;
e. matching popularity trajectory against market analysis; and
f. feeding results from steps a-e into a distribution entity which determines distribution opportunities based on rankings and target audiences discovered.
